(19) United States
(12) Patent Application Publication
(10) Pub. No.: US 2025/0121725 A1
(43) Pub. Date: Apr. 17, 2025

(54) DECENTRALIZED NETWORK FOR PREDICTIVE SELECTION OF EV CHARGING INFRASTRUCTURE

(71) Applicant: Plug P2P, Inc., Birmingham, MI (US)

(72) Inventor: Amal Campbell, Birmingham, MI (US)

(21) Appl. No.: 18/914,256

(22) Filed: Oct. 13, 2024

Related U.S. Application Data
(60) Provisional application No. 63/590,121, filed on Oct. 13, 2023.

(51) Int. Cl. B60L 53/62; B60L 58/12

(52) U.S. Cl. CPC B60L 53/62; B60L 58/12; B60L 2240/72

(57) ABSTRACT

A device includes program instructions executable by one or more processors that, when executed, cause the one or more processors to perform operations. The operations include acquiring data indicative of a geometry of a charging feature of a vehicle for charging a battery of the vehicle and a rated power input for the battery of the vehicle. The operations include acquiring data indicative of a geometry of a charging feature of charging infrastructure and a rated power output for the charging infrastructure. The operations include matching the vehicle to the charging infrastructure based at least on the geometry of the charging feature of the vehicle being compatible with the geometry of the charging feature of the charging infrastructure. The operations include automatically controlling an operation of at least one of the vehicle or the charging infrastructure when the vehicle is connected with the charging infrastructure.

### CROSS-REFERENCE TO RELATED APPLICATIONS

This application claims the benefit of U.S. Provisional Application No. 63/590,121, filed on Oct. 13, 2023, the content of which is hereby incorporated herein in its entirety for all purposes.

### FIELD

The present disclosure relates generally to the field of electric vehicle (EV) charging infrastructure, and more specifically, to decentralized networks for predictive selection of EV charging infrastructure.

### BACKGROUND

Vehicles (e.g., electric vehicles (EVs)) may utilize power from a battery to propel the vehicle along a trajectory. Utilizing power from the battery depletes the battery and thus may require charging (e.g., recharging) via, for example, charging infrastructure. Increasing EV adoption has led to an increase in the use of charging infrastructure. Charging infrastructure may be incompatible with certain EVs, and vice versa. Charging infrastructure is often distributed across geographic regions.

### SUMMARY

One aspect of the disclosure is a non-transitory computer-readable storage device including program instructions executable by one or more processors that, when executed, cause the one or more processors to perform operations. The operations may include acquiring data indicative of a geometry of a charging feature of a vehicle for charging a battery of the vehicle and a rated power input for the battery of the vehicle. The operations may also include acquiring data indicative of a geometry of a charging feature of charging infrastructure and a rated power output for the charging infrastructure. The operations may also include matching the vehicle to the charging infrastructure based at least on the geometry of the charging feature of the vehicle being compatible with the geometry of the charging feature of the charging infrastructure. The operations may also include automatically controlling an operation of at least one of the vehicle or the charging infrastructure when the vehicle is connected with the charging infrastructure such that an actual power output from the charging infrastructure is compatible with a rated power input for the battery of the vehicle, or an actual power input to the battery of the vehicle is compatible with the rated power output for the charging infrastructure.

Another aspect of the disclosure is a device associated with a user of a vehicle, the vehicle including a battery configured to provide power to move the vehicle, the battery having a charge level. The device includes one or more memories and one or more processors that are configured to execute instructions that are stored in the one or more memories. The instructions, when executed, may cause the one or more processors to determine an estimated range for the vehicle based on the charge level for the battery of the vehicle. The instructions, when executed, may also cause the one or more processors to acquire data indicative of a location and a current availability for each of one or more units of charging infrastructure. The instructions, when executed, may also cause the one or more processors to identify one or more in-range units of charging infrastructure from the one or more units of charging infrastructure that have a distance to the vehicle that is within the estimated range for the vehicle. The instructions, when executed, may also cause the one or more processors to continuously update the estimated range for the vehicle based on the charge level for the battery as the vehicle moves. The instructions, when executed, may also cause the one or more processors to continuously update the one or more in-range units of charging infrastructure that are identified from the one or more units of charging infrastructure based on the estimated range for the vehicle that is continuously updating. The instructions, when executed, may also cause the one or more processors to display identifying information for the one or more in-range units of charging infrastructure that are identified from the one or more units of charging infrastructure and that are currently available.

Another aspect of the disclosure is a device associated with a vehicle, the vehicle including a battery configured to provide power to control a function of the vehicle. The device includes one or more memories and one or more processors that are configured to execute instructions that are stored in the one or more memories. The instructions, when executed, may cause the one or more processors to acquire data indicative of a real-time availability and a future availability for using each of one or more units of charging infrastructure. The instructions, when executed, may also cause the one or more processors to determine a first penalty for using each of the one or more units of charging infrastructure within a temporal threshold based at least on the real-time availability of each of the one or more units of charging infrastructure. The instructions, when executed, may also cause the one or more processors to determine a second penalty for using each of the one or more units of charging infrastructure at a future time beyond the temporal threshold based at least on the future availability of the one or more units of charging infrastructure. The instructions, when executed, may also cause the one or more processors to continuously update the second penalty for using each of the one or more units of charging infrastructure at the future time beyond the temporal threshold based at least on the future availability for using each of the one or more units of charging infrastructure. The instructions, when executed, may also cause the one or more processors to display identifying information for at least one of the one or more units of charging infrastructure and at least one of the first penalty or the second penalty for using the at least one of the one or more units of charging infrastructure.

### BRIEF DESCRIPTION OF THE DRAWINGS

FIG. 1 is a schematic illustration of a vehicle consuming power from a battery.

FIG. 2 is a schematic illustration of the vehicle of FIG. 1 traveling in a geographic region.

FIG. 3 is a side view illustration of the vehicle of FIG. 1 and examples of charging inlets for the vehicle.

FIG. 4 is a side view illustration of a charging station and examples of charging connectors for the charging station.

FIG. 5 is a side view illustration of private property and examples of electrical outlets for the private property.

FIG. 6 is a side view illustration of a vehicle and a portable charger and examples of electrical plugs for the portable charger.

FIG. 7 is a side view illustration of an example of private property with charging infrastructure.

FIG. 8 is a side view illustration of another example of private property with charging infrastructure.

FIG. 9 is a side view illustration of another example of private property with charging infrastructure.

FIG. 10 is a block diagram of an example of a system and a network environment in accordance with one or more implementations.

FIG. 11 is a block diagram of an example computing device in accordance with one or more implementations.

FIG. 12A is a schematic illustration of matching guest devices to host devices in accordance with one or more implementations.

FIG. 12B is a schematic illustration of filtering charging infrastructure in accordance with one or more implementations.

FIG. 12C is a schematic illustration of filtering suitable charging infrastructure in accordance with one or more implementations.

FIG. 13 is a flowchart of an example method for controlling operation(s) of vehicle(s) and/or charging infrastructure in accordance with one or more implementations.

FIG. 14 is a flowchart of another example method for controlling operation(s) of vehicle(s) and/or charging infrastructure in accordance with one or more implementations.

FIG. 15 is a flowchart of another example method for controlling operation(s) of vehicle(s) and/or charging infrastructure in accordance with one or more implementations.

FIG. 16 is a flowchart of an example method for a host in accordance with one or more implementations.

FIGS. 17A-17H are illustrations of example graphical user interfaces (GUIs) for a host in accordance with one or more implementations.

FIG. 18 is a flowchart of an example method for a guest in accordance with one or more implementations.

FIG. 19A-19I are illustrations of example GUIs for a guest in accordance with one or more implementations.

### DETAILED DESCRIPTION

The disclosure herein relates to systems and methods for deploying and operating decentralized networks for predictive selection of EV charging infrastructure. Predictive selection of EV charging infrastructure may be utilized, for example, to allocate EV charging infrastructure that is distributed across geographic regions. Charging infrastructure (e.g., charging stations, electrical outlets, etc.) is often distributed geographically based on, for example, the availability of electrical systems that may support the electrical power loads required to implement the charging infrastructure. Different charging infrastructure may have different characteristics (e.g., operating voltage requirements, power supply capabilities, charging connector types, etc.). Similarly, vehicles that use one or more batteries as a means of propulsion (e.g., electric vehicles, hybrid vehicles, etc.) may have different characteristics (e.g., charging connector type requirements, power receipt capabilities, etc.). Accordingly, certain charging infrastructure may be compatible with some vehicles and may be incompatible with other vehicles. Stated differently, certain vehicles may be compatible with some charging infrastructure and may be incompatible with other charging infrastructure.

For example, some charging infrastructure (e.g., a charging station) may include a J1772 type charging connector and be configured to supply (e.g., output) 1.4 kilowatts of power (e.g., may be a Level 1 charger), while other charging infrastructure (e.g., another charging station) may include a NACS type charging connector and be configured to supply (e.g., output) 10.4 kilowatts of power (e.g., may be a Level 2 charger). As another example, some charging infrastructure (e.g., an electrical outlet) may include a NEMA 5-15 type electrical outlet and be configured to supply (e.g., output) 1.4 kilowatts of power (e.g., may be a Level 1 charger), while other charging infrastructure (e.g., another electrical outlet) may include a NEMA 14-50 type electrical outlet and be configured to supply (e.g., output) 8.3 kilowatts of power (e.g., may be a Level 2 charger). Furthermore, as an example, some vehicles (e.g., an EV) may be configured to receive a maximum of 2 kilowatts (e.g., may be configured for use with a Level 1 charger) and may be equipped with a J1772 charging inlet, while other vehicles (e.g., another EV) may be configured to receive a maximum of 350 kilowatts (e.g., may be configured for use with a DC Fast Charger) and may be equipped with a CHAdeMO type charging inlet. As another example, some vehicles (e.g., an EV) may be configured to receive a maximum of 2 kilowatts (e.g., may be configured for use with a Level 1 charger) and may be equipped with a J1772 charging inlet, while other vehicles (e.g., another EV) may be configured to receive a maximum of 19 kilowatts (e.g., may be configured for use with a Level 2 charger) and may also be equipped with a J1772 charging inlet.

Incompatibility between vehicles and charging infrastructure may result in risk of damage to the vehicle and/or to the charging infrastructure, and/or may result in safety risks to persons near the vehicle and/or the charging infrastructure (e.g., a user of the vehicle or the charging infrastructure). For example, where a vehicle is connected to charging infrastructure that is configured to supply more power than the vehicle is configured to receive (e.g., more power than a battery of the vehicle is configured to receive), damage to the vehicle and related electronics may result. Such damage to the vehicle may include, inter alia, overheating of the vehicle's battery (e.g., resulting in thermal runaway, degradation of battery efficiency or lifespan, fires, etc.) and/or electrical damage to the vehicle's onboard electronics (e.g., electrical damage to a battery management system (BMS) of the vehicle, etc.).

As another example, where a vehicle is connected to charging infrastructure that is configured to supply less power than the vehicle is configured to receive (e.g., less power than a battery of the vehicle is configured to receive), damage to the charging infrastructure and related electronics may result. Such damage to the charging infrastructure may include, inter alia, overheating the charging infrastructure (e.g., resulting in component failures, fires, etc.) and/or overloading circuits connected to (e.g., integrated with) the charging infrastructure (e.g., resulting in power surges, circuit breaker malfunctions, component failures, fires, etc.). In either scenario, risk to the safety of persons present near the vehicle and/or charging infrastructure may also result. For example, damage to the vehicle and/or the charging infrastructure may result in exposed electrical components that may pose a risk of electrocution. Furthermore, in cases of severe damage to the vehicle and/or charging infrastructure, fires or arc flashes may occur.

To mitigate the risk of such damage and/or harm, a system may be implemented that automatically selects and schedules a charging station for charging a vehicle based on the properties (e.g., capabilities and requirements) of the vehicle and the charging infrastructure. By automatically selecting and scheduling a charging station for charging a vehicle based on the properties of the vehicle and the charging infrastructure, vehicles may be matched with charging infrastructure (or vice versa) such that potentially dangerous charging scenarios (e.g., charging scenarios between a vehicle and incompatible charging infrastructure) may be avoided and/or prevented.

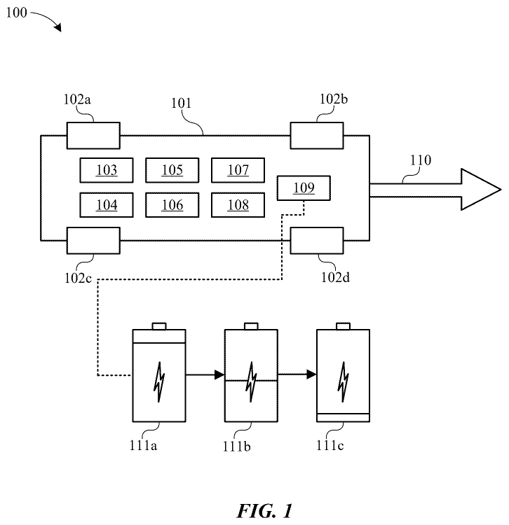

FIG. 1 is a schematic illustration of a vehicle 100. The vehicle 100 may be a road-going vehicle that includes a vehicle body 101 and supported by wheels 102 (e.g., four of the wheels). For example, the vehicle 100 may be a passenger vehicle that includes a passenger compartment that is configured to carry one or more passengers. As another example, the vehicle 100 may be a cargo vehicle that is configured to carry cargo items in a cargo compartment. As another example, the vehicle 100 may be a motorcycle. As another example, the vehicle may be a recreational vehicle (an RV). In alternative implementations, some or all of the components that are described with respect to the vehicle 100 may be incorporated in different types of vehicles, such as marine vehicles or aircraft.

The vehicle 100 may include vehicles systems that are connected to the vehicle body 101 and/or the wheels 102 of the vehicle 100 and that cause, control, regulate, or otherwise affect operations of the vehicle 100 (e.g., motion of the vehicle 100, etc.). For example, in the illustrated implementation, the vehicle 100 includes a suspension system 103, a propulsion system 104, a braking system 105, a steering system 106, a sensing system 107, and a control system 108. The vehicle 100 also includes one or more batteries 109 that are configured to provide power to affect one or more operations of the vehicle 100 (e.g., motion of the vehicle 100, etc.).

The vehicle body 101 is a structural component of the vehicle 100 through which other components are interconnected and supported. For example, the vehicle body 101 may include or define a passenger compartment for carrying passengers. The vehicle body 101 may include structural components (e.g., a frame, subframe, unibody, monocoque, etc.) and aesthetic components (e.g., exterior body panels). The wheels 102 are connected to the vehicle body 101, for example, by components of the suspension system 103. As an example, the wheels 102 may include four of the wheels 102 that support the vehicle 100, and each of the wheels 102 may have a pneumatic tire mounted thereto.

The suspension system 103 supports a sprung mass of the vehicle 100 with respect to an unsprung mass of the vehicle 100. The suspension system 103 is configured to control vertical motion of the wheels 102 of the vehicle 100 relative to the vehicle body 101, for example, to ensure contact between the wheels 102 and a surface of a roadway and to reduce undesirable movements of the vehicle body 101.

The propulsion system 104 includes propulsion components that are configured to cause motion of the vehicle 100 (e.g., by causing the vehicle to accelerate). The propulsion system 104 may include components that are operable to generate torque and deliver that torque to the wheels 102. Examples of components that may be included in the propulsion system 104 include motors, gearboxes, and propulsion linkages (e.g., drive shafts, half shafts, etc.).

The braking system 105 provides deceleration torque for decelerating the vehicle 100. The braking system 105 may include friction braking components such as disk brakes or drum brakes. The braking system 105 may use an electric motor of the propulsion system 104 to decelerate the vehicle by electromagnetic resistance, which may be part of battery charging in a regenerative braking configuration.

The steering system 106 is operable to cause the vehicle to turn by changing a steering angle of one or more wheels of the vehicle 100, for example, using actuators (e.g., in a drive-by-wire and/or autonomously driving implementation) or a manually operating steering device.

The sensing system 107 includes sensors for observing conditions of the vehicle 100 (e.g., acceleration and conditions of the various systems and their components), external conditions of the environment around the vehicle 100, and/or internal conditions of the environment within a passenger compartment. The sensing system 107 may include sensors of various types, including dedicated sensors and/or components of various systems. For example, actuators may incorporate sensors or portions of actuators may function as sensors such as by measuring current draw of an electric motor or by sensing the position of an output shaft of an electric motor. The sensing system 107 may also include sensors configured for autonomous driving of the vehicle 100. For example, the sensing system 107 may include sensors configured to provide real-time data about the environment around the vehicle 100 as the vehicle 100 moves. Examples of sensors that may be included with the sensing system 107 for autonomous driving include cameras, radar, lidar ultrasonic sensors, GPS systems, and other sensors.

The control system 108 includes communication components (e.g., for receiving sensor signals from the sensing system 107 and sending control signals) and processing components (e.g., for processing the sensor signals from the sensing system 107 and determining control operations), such as a controller. In some implementations, the control system 108 may be configured for autonomous driving of the vehicle 100. For example, the control system 108 may be configured to process sensor signals from the sensing system 107, determine a control operation for the steering system 106 based on (e.g., based in part on) the signals, and send the control operation to the steering system 106 to cause the steering system 106 to change the steering angle of the vehicle 100. As another example, the control system 108 may be configured to process sensor signals from the sensing system 107, determine a control operation for the propulsion system 104 based on the signal, and send the control operation to the propulsion system 104 to cause the propulsion system 104 to change an acceleration of the vehicle 100. The control system 108 may be a single system or multiple related systems. For example, the control system 108 may be a distributed system including components that are included in other systems of the vehicle 100, such as the suspension system 103, the propulsion system 104, the braking system 105, the steering system 106, the sensing system 107, and/or other systems.

The one or more batteries 109 are electrical energy storage devices (e.g., each including many individual electrochemical cells) that are configured to supply electrical power to the other systems of the vehicle 100. For example, the one or more batteries 109 may be configured to supply electrical power to the propulsion system 104 to move (e.g., accelerate) the vehicle 100 along a trajectory 110 (e.g., defined by the steering system 106), for example, by supplying electrical power to electric motors of the propulsion system 104. As another example, the one or more batteries 109 may be configured to supply electrical power to the steering system 106 to augment a driver's steering input. As another example, the one or more batteries 109 may be configured to supply electrical power to the steering system 106 to activate the steering system 106 in autonomous driving implementations. As another example, the one or more batteries 109 may be configured to supply electrical power to one or more external lights (not shown) of the vehicle 100 to illuminate the one or more external lights. As another example the one or more batteries 109 may be configured to supply electrical power to the control system 108 to cause a display (not shown) of the vehicle 100 to display an image.

The one or more batteries 109 may have a charge level 111 (e.g., may each have the charge level 111). When the one or more batteries 109 supply electrical power to the other systems of the vehicle 100, the charge level 111 of the one or more batteries 109 may decrease (e.g., deplete). For example, where the one or more batteries 109 supply electrical power to the propulsion system 104, the charge level 111 of the one or more batteries 109 (e.g., the charge level 111 of each of the one or more batteries 109) may deplete as the propulsion system 104 moves the vehicle 100 along the trajectory 110. As shown, the charge level 111 of the one or more batteries 109 may move from a high charge level 111a (e.g., a full charge level) to an intermediate charge level 111b as, for example, the vehicle 100 moves along the trajectory 110. Furthermore, the charge level 111 of the one or more batteries 109 may move from the intermediate charge level 111b to a low charge level 111c (e.g., a depleted charge level) as, for example, the vehicle 100 continues along the trajectory 110. The one or more batteries 109 are chargeable (e.g., rechargeable) such that the electrical power may be supplied (e.g., input) to the one or more batteries 109 (e.g., each of the one or more batteries 109) to increase the charge level 111 of the one or more batteries 109. For example, electrical power may be supplied to the one or more batteries 109 to move the charge level 111 from the low charge level 111c to the intermediate charge level 111b or to the high charge level 111a. As another example, electrical power may be supplied to the one or more batteries 109 to move the charge level 111 from the intermediate charge level 111b to the high charge level 111a. In some implementations, the one or more batteries 109 may be charged by electrical power supplied by the braking system 105 where the braking system 105 is configured for regenerative braking. The charge level 111 may be referred to herein as a current charge of the one or more batteries 109.

The one or more batteries 109 may be any suitable type of battery. For example, the one or more batteries 109 may include one or more lead-acid batteries, one or more lithium-ion batteries, or some other form of electrical energy storage device. Where the vehicle 100 utilizes an internal combustion engine to supply power to the propulsion system 104, the one or more batteries 109 may be one or more lead-acid batteries. On the other hand, where the vehicle 100 utilizes the one or more batteries 109 to supply electrical power to the propulsion system 104, the one or more batteries 109 may be one or more lithium-ion batteries. Where the vehicle 100 utilizes the one or more batteries 109 to supply electrical power to the propulsion system 104, the vehicle 100 may be referred to herein as an electric vehicle (EV).

Lithium-ion batteries generally have higher energy densities as compared to other batteries (e.g., lead-acid batteries), enabling lithium-ion batteries to store large amounts of energy in a small package size. For example, a lithium-ion battery packageable in the vehicle body 101 may have a capacity within in a range between about 30 kWh and 200 kWh, or may have a greater capacity. Furthermore, lithium-ion batteries generally have faster charge times and longer operational lifespans than other batteries, such as lead-acid batteries.

Where the vehicle 100 is an EV, the charge level 111 of the one or more batteries 109 may determine (e.g., define) a range for the vehicle 100. The range for the vehicle as used herein refers to a distance at which the vehicle 100 may travel before the one or more batteries 109 are depleted and may no longer supply electrical power to the systems of the vehicle 100 (e.g., the propulsion system 104 to move the vehicle 100). The range for the vehicle 100 may also be dependent upon the collective capacity of the one or more batteries 109, the aerodynamics of the vehicle 100, the weight of the vehicle 100, the surface on which the vehicle 100 travels, the temperature of the one or more batteries 109, the temperature of the environment around the vehicle 100, and other factors. For example, where the one or more batteries 109 have a collective capacity of 50 kWh and have the high charge level 111a, the vehicle 100 may have a range of about 220 miles. As another example, where the one or more batteries 109 have a collective capacity of 50 kWh and have the intermediate charge level 111b, the vehicle 100 may have a range of about 110 miles.

Furthermore, where the vehicle 100 is an EV, the control system 108 may include a battery control module (BCM) that is configured to manage the operation and performance of the one or more batteries 109. For example, the BCM may monitor parameters of the one or more batteries 109 such as the voltage, current, temperature, and the charge level 111, and may regulate the flow of electrical power through the vehicle 100 (e.g., through the control system 108, the one or more batteries 109, etc.) during charging and/or discharging to mitigate (e.g., prevent) conditions that may damage the one or more batteries 109, such as overcharging, overheating, and excessive discharge. Furthermore, where the one or more batteries 109 includes one or more individual electrochemical cells, the BCM may be operable to balance the electrochemical cells to optimize performance and prolong the operating life of the one or more batteries 109. In some implementations, the BCM may not be included with the control system 108 and may instead be a separate system or integrated into some other system of the vehicle 100 (e.g., the one or more batteries 109). Furthermore, in some implementations, each of the one or more batteries 109 may include an independent BCM.

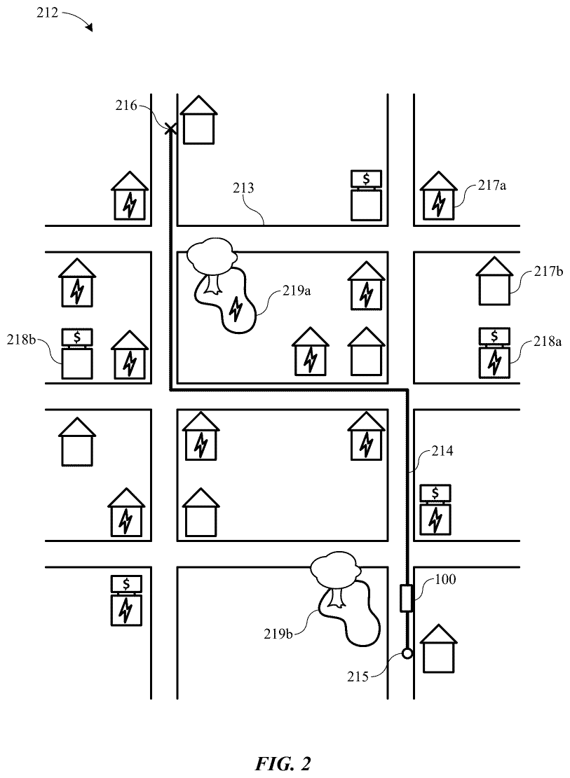

FIG. 2 is a schematic illustration of a geographic region 212. The geographic region 212 may comprise any size region of land. For example, as shown, the geographic region 212 depicts a region having five of the roads 213 and twenty-two properties. In other implementations, the geographic region 212 may be larger or smaller. For example, the geographic region 212 may be a county, a state, or a country (e.g., including many of the roads 213 and properties). As another example, the geographic region 212 may be a neighborhood, a single block, or a single road (e.g., including only a few properties). In the illustrated example, the vehicle 100 is shown traveling along a route 214 (e.g., a planned route) that extends along the roads 213 from a starting point 215 to a destination 216. The geographic region 212 may include one or more properties such as, for example, residential properties 217, commercial properties 218, and public properties 219. The residential properties 217 may include residential homes, condominiums, apartments, or some other property or structure intended (e.g., zoned) for residential use. The commercial properties 218 may include stores, shops, markets, restaurants, parking lots, EV fleet depots, or some other property or structure intended (e.g., zoned) for commercial use. The public properties 219 may include parks, streets, playgrounds, parking lots, government buildings, or some other property or structure intended (e.g., zoned) for public use. According to some examples, one or more of the residential properties 217, the commercial properties 218, and the public properties 219 may be combined, for example, in the instance of a leasing office for an apartment complex or the like where the commercial leasing office is combined with the residential apartments. Furthermore, as shown, one or both of the starting point 215 and the destination 216 may correspond to respective ones of the residential properties 217, the commercial properties 218, or the public properties 219.

Each of the residential properties 217, the commercial properties 218, and the public properties 219 may include charging infrastructure that is configured to supply (e.g., output) electrical power to the one or more batteries 109 of the vehicle 100 to charge (e.g., recharge) the one or more batteries 109. As used herein, charging infrastructure refers to any system or device that is operable to supply electrical power for charging an EV. For example, charging infrastructure may include charging stations, electrical outlets, wireless charging pads, and the like. Furthermore, as used herein, the residential properties 217 that include charging infrastructure are referred to as connected residential properties 217a and the residential properties 217 that do not include charging infrastructure are referred to as unconnected residential properties 217b. Similarly, as used herein, the commercial properties 218 that include charging infrastructure are referred to as connected commercial properties 218a and the commercial properties 218 that do not include charging infrastructure are referred to as unconnected commercial properties 218b. Similarly, as used herein, the public properties 219 that include charging infrastructure are referred to as connected public properties 219a and the public properties 219 that do not include charging infrastructure are referred to as unconnected public properties 219b.

As the vehicle 100 travels along the route 214 (e.g., a planned route), the vehicle 100 may consume electrical power from the one or more batteries 109, resulting in the charge level 111 of the one or more batteries 109 decreasing. Accordingly, the vehicle 100 may require (e.g., the driver and/or other user of the vehicle 100 may desire) recharging along the route 214, for example, from the charging infrastructure of the connected residential properties 217a, the connected commercial properties 218a, and/or the connected public properties 219a. However, generally, only the charging infrastructure of the connected public properties 219a is available to vehicles (e.g., the vehicle 100) without permission from the owners or holders (e.g., persons who have control over the property) of the connected residential properties 217a or connected commercial properties 218a.

As shown in the illustrated example, the prominence of charging infrastructure on residential properties 217 and the commercial properties 218 is much greater than that of the public properties 219. For example, charging infrastructure on the residential properties 217 may account for between about 70%-80% of total charging infrastructure in a given geographic region and charging infrastructure on the commercial properties 218 may account for between about 5%-10% of total charging infrastructure in a given geographic region. On the other hand, charging infrastructure on the public properties 219 may account for only between about 15%-20% of total charging infrastructure in a given geographic region. Accordingly, it may be desired that the vehicle 100 have access to not only the connected public properties 219a, but the connected residential properties 217a and the connected commercial properties 218a as well. As used herein, the connected residential properties 217a and the connected commercial properties 218a may be collectively referred to herein as connected private properties 242.

As explained previously, different charging infrastructure may have different characteristics (e.g., operating voltage requirements, power supply capabilities, charging connector types, etc.). Similarly, EVs (e.g., the vehicle 100) may have different characteristics (e.g., charging inlet type requirements, power receipt capabilities, etc.). Accordingly, certain charging infrastructure may be compatible with some EVs and may be incompatible with other EVs. Stated differently, certain EVs may be compatible with some charging infrastructure and may be incompatible with other charging infrastructure. Incompatibility between EVs and charging infrastructure may result in risk of damage to the EV and/or to the charging infrastructure, and/or may result in safety risks to persons near the EV and/or the charging infrastructure (e.g., a user of the EV or the charging infrastructure). Accordingly, owners and/or holders (e.g., persons who have control over the property) of the connected residential properties 217a and/or the connected commercial properties 218a may be hesitant to grant permission for EVs (e.g., the vehicle 100) to use their associated charging infrastructure absent a reliable system for matching EVs (e.g., the vehicle 100) to compatible charging infrastructure while excluding incompatible EV and charging infrastructure combinations.

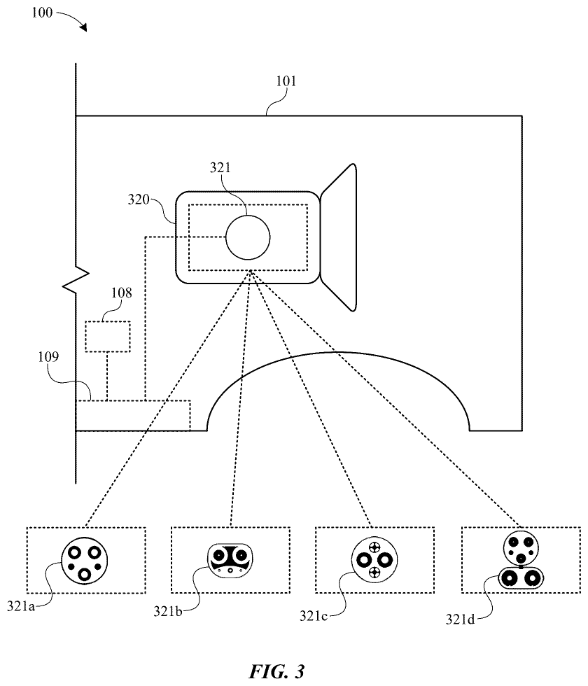

FIG. 3 is a side view illustration of a portion of the vehicle body 101 of the vehicle 100. In the illustrated implementation, the vehicle 100 is an EV and thus includes the one or more batteries 109 and the control system 108. For clarity purposes, other systems of the vehicle 100 (e.g., the wheels 102) have been omitted from the illustration of FIG. 3. As shown, the vehicle body 101 includes a port 320 through which the one or more batteries 109 may be accessed (e.g., indirectly accessed). For example, the port 320 may provide indirect access to the one or more batteries 109 through a charging inlet 321. The charging inlet 321 may be in electrical communication with the one or more batteries 109 via, for example, one or more wires and/or other components (e.g., a BCM of the control system 108). The charging inlet 321 may be configured to engage with (e.g., interface with) a corresponding connector of charging infrastructure (explained below) such that the one or more batteries 109 may be charged via the charging infrastructure. In some implementations, the sensing system 107 of the vehicle 100 may include one or more sensors (e.g., proximity sensors, contact sensors, etc.) for detecting whether the charging inlet 321 is currently connected with a corresponding connector of charging infrastructure, which may be disposed on the charging inlet 321, the port 320, or at some other location.

The charging inlet 321 may have a certain geometry (e.g., may have a certain charging inlet type). For example, as shown, the charging inlet 321 may be a J1772-type charging inlet 321a, a NACS-type charging inlet 321b, a CHAdeMO-type charging inlet 321c, a CCS-type charging inlet 321d, or some other type of the charging inlet 321. The geometry of the charging inlet 321 may relate to a rated power input for the vehicle 100. As used herein, rated power input refers to the maximum power input for the vehicle 100 to safely charge the one or more batteries 109 of the vehicle 100 as specified in, for example, the engineering specifications for the vehicle 100. The rated power input for the vehicle 100 may depend on the properties of the one or more batteries 109 (e.g., composition, size, etc.) and/or related systems of the vehicle 100 (e.g., wire gauges, component sensitivities to electricity, etc.).

As explained previously, exceeding the rated power input of the vehicle 100 may result in damage to the vehicle 100 (e.g., may result in damage to the one or more batteries 109 and/or components to which the one or more batteries 109 are connected). In some implementations, the BCM of the control system 108 may be configured to modify the characteristics of the electrical power input to the charging inlet 321. For example, the BCM may be configured to reduce (e.g., throttle) the electrical power (e.g., the amperage) input to the charging inlet 321 based on, for example, the properties of the one or more batteries 109 and/or related systems of the vehicle 100.

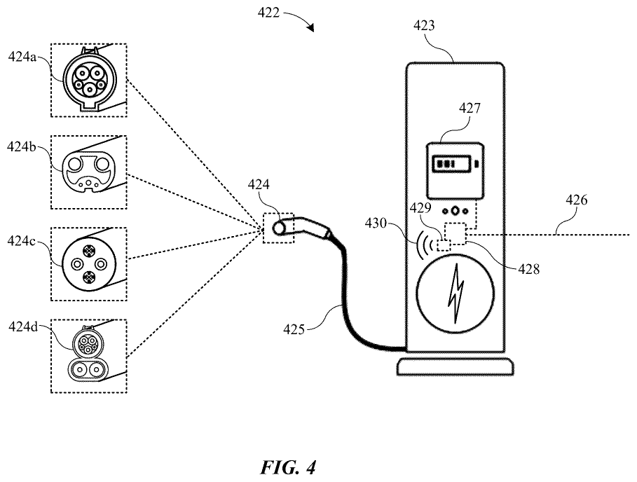

FIG. 4 is a side view illustration of an example of charging infrastructure, and more specifically, of a charging station 422. Charging infrastructure may generally be categorized as Level 1, Level 2, and DC Fast Charger charging infrastructure which relate to a rated power output for the charging infrastructure. As used herein, rated power output refers to the maximum power output for the charging infrastructure to safely charge the one or more batteries 109 of the vehicle 100 as specified in, for example, the engineering specifications for the charging infrastructure. The rated power output for the charging infrastructure may depend on the properties of the charging infrastructure (e.g., wire gauges, circuit breakers, etc.).

Level 1 infrastructure generally operates at a voltage of about 120V and output between about 10 A and 16 A of current, resulting in a rated power output of between about 1.2 kW and 1.9 kW. Level 2 infrastructure generally operates at a voltage of between about 208V and 240V and output between about 16 A and 80 A of current, resulting in a rated power output of between about 3.3 kW and 19.2 kW. DC Faster Charger infrastructure generally operates at a voltage of between about 400V and 900V and output between about 125 A and 400 A of current, resulting in a rated power output of between about 50 kW and 350 kW. As explained previously, exceeding the rated power output of the charging infrastructure may result in damage to the charging infrastructure.

The charging station 422 may include a charging station body 423, a charging connector 424, and a cable 425 electrically connecting the charging connector 424 to the charging station body 423. The charging station 422 may be electrically connected to a power source 426 (e.g., the power grid). The charging station body 423 is a structural component of the charging station 422 through which other components are interconnected and supported. The charging station body 423 may include structural components (e.g., a frame, subframe, etc.) and aesthetic components (e.g., exterior panels).

The charging connector 424 may be configured to engage with (e.g., interface with) the charging inlet 321 of the vehicle 100 such that the charging station 422 may supply electrical power to the vehicle 100 (e.g., to the one or more batteries 109) (see FIG. 3). Similar to the charging inlet 321 (see FIG. 3), the charging connector 424 may have a certain geometry (e.g., may have a certain charging inlet type). For example, as shown, the charging connector 424 may be a J1772-type charging connector 424a, a NACS-type charging connector 424b, a CHAdeMO-type charging connector 424c, a CCS-type charging connector 424d, or some other type of charging connector. The geometry of the charging connector 424 may relate to a rated power output for the charging station 422. For example, the geometry of the charging connector 424 may relate to whether the charging station 422 is Level 1 infrastructure, Level 2 infrastructure, or DC Fast Charger infrastructure. Generally, the J1772-type charging connector 424a is associated with Level 1 infrastructure and Level 2 infrastructure. The NACS-type charging connector 424b is generally associated with Level 1 infrastructure, Level 2 infrastructure, and DC Fast Charger infrastructure. The CHAdeMO-type charging connector 424c is generally associated with DC Fast Charger infrastructure. The CCS-type charging connector 424d is also generally associated with DC Fast Charger infrastructure.

Types of the charging connector 424 may be compatible with some types of the charging inlet 321 and incompatible with other types of the charging inlet 321. For example, the J1772-type charging connector 424a may be compatible with (e.g., releasably receivable by) the J1772-type charging inlet 321a and the CCS-type charging inlet 321d, and may not be compatible with (e.g., releasably receivable by) the NACS-type charging inlet 321b or the CHAdeMO-type charging inlet 321c. The NACS-type charging connector 424b may be compatible with (e.g., releasably receivable by) the NACS-type charging inlet 321b, and may not be compatible with (e.g., releasably receivable by) any of the other types of charging inlets 321. The CHAdeMO-type charging connector 424c may be compatible with (e.g., releasably receivable by) the CHAdeMO-type charging inlet 321c, and may not be compatible with (e.g., releasably receivable by) any of the other types of charging inlet 321. The CCS-type charging connector 424d may be compatible with (e.g., releasably receivable by) the CCS-type charging inlet 321d, and may not be compatible with (e.g., releasably receivable by) any of the other types of the charging inlet 321.

The charging station 422 may also include a display 427, a controller 428, and a transceiver 429 (e.g., an antenna). The display 427 of the charging station 422 may be configured to display information about the charging station 422 (e.g., the power, voltage, and/or amperage being supplied by the charging station 422). In some implementations, the display 427 may display an estimated Furthermore, in some implementations, the display 427 may be configured to display information about the vehicle 100 when the vehicle 100 is connected to the charging station 422 via the charging connector 424. For example, the display 427 may be configured to display a charge status (e.g., the charge level 111) of the vehicle 100, an estimated charge time for the vehicle 100 based on characteristics of the vehicle 100, an estimated range for the vehicle 100 based on the charge status (e.g., the charge level 111), an estimated time at which the vehicle 100 may require recharging, or other characteristics of the vehicle 100, or other information about the vehicle 100.

The controller 428 may include communication components (e.g., for receiving signals from other components such as the transceiver 429) and processing components (e.g., for processing signals from other components such as the transceiver 429 and determining control operations). The controller 428 may be a single system or multiple related systems. For example, the controller 428 may be a distributed system including components that are included in other systems of the charging station 422. In some implementations, the controller 428 may be configured to modify the characteristics of the electrical power received from the power source 426. For example, the controller 428 may be configured to reduce (e.g., throttle) the electrical power (e.g., the amperage) that is received from the power source 426 such that the electrical power output by the charging connector 424 is less than the electrical power that is received from the power source 426. As another example, the controller 428 may be configured to modify (e.g., transform) the amperage and voltage of the electrical power that is received from the power source 426 such that the amperage and voltage of the electrical power that is output by the charging connector 424 is different than the amperage and voltage of the electrical power that is received from the power source 426. In some implementations, the controller 428 may be configured to monitor a power output of the charging station 422 to determine how much electrical power has been consumed while charging the vehicle 100. Furthermore, in some implementations, the charging station 422 may include a timing device for monitoring a temporal duration with which the vehicle 100 is connected to the charging station 422 (e.g., receiving power from the charging station 422) and/or is present on the connected private properties 242.

The transceiver 429 may be configured to send and receive signals 430 to and from, for example, the vehicle 100 (e.g., the control system 108 of the vehicle 100 or some other system of the vehicle 100), another device, and/or other components of the charging station 422 (e.g., the controller 428, the display 427, etc.) such that the charging station 422 may wirelessly communicate with the vehicle 100 (e.g., the control system 108 of the vehicle 100), other device, and/or other components of the charging station 422. In some implementations, the transceiver 429 may be configured to wirelessly communicate with the vehicle 100 such that the display 427 may display information about the vehicle 100 without the vehicle 100 being connected to the charging station 422 via the charging connector 424.

In some implementations, the charging station 422 may include one or more sensors (not shown) that are configured to detect whether the charging connector 424 is currently connected with (e.g., engaged with, removably received by) the charging inlet 321 (see FIG. 3). The one or more sensors may, for example, be located on the charging connector 424, a handle for the charging connector 424, or at some other location. For example, upon detecting that the charging connector 424 is currently connected with the charging inlet 321, the sensors may send a signal to the controller 428. The controller 428 may process the signal, determine a control operation for the charging station 422 based on the detected connection, and send the control signal to cause the charging station 422 to output electrical power via the charging connector 424.

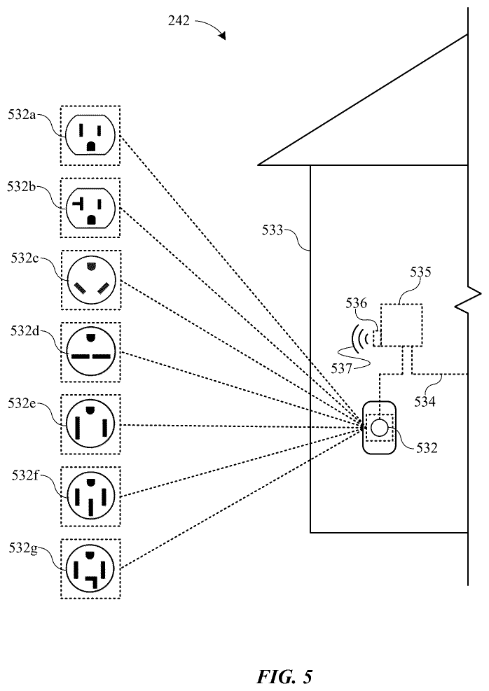

FIG. 5 is a side view illustration of another example of charging infrastructure, and more specifically, an electrical outlet 532 that is disposed on a structure 533 of residential or commercial property (e.g., the residential property 217 or the commercial property 218) such that the property may be described as connected private property (e.g., the connected private property 242). The electrical outlet 532 may be configured to engage with (e.g., interface with) a corresponding electrical plug of a portable charger (explained below) for a vehicle (e.g., the vehicle 100) such that the one or more batteries 109 may be charged via the electrical outlet 532. The electrical outlet 532 may be electrically connected to a power source 426 (e.g., the power grid, the electrical system of the private property 242, or the like). The connected private property 242 may also include a controller 535 and a transceiver 536 (e.g., an antenna). In some implementations, the electrical outlet 532 may be a smart outlet, such that the controller 535 is integrated with the electrical outlet 532. Alternatively, where the electrical outlet 532 is a smart outlet, the electrical outlet 532 may include separate control electronics.

The controller 535 may include communication components (e.g., for receiving signals from other components such as the transceiver 536) and processing components (e.g., for processing signals from other components such as the transceiver 536 and determining control operations). The controller 535 may be a single system or multiple related systems. For example, the controller 535 may be a distributed system including components that are included in other systems of the connected private property 242. In some implementations, the controller 535 may be configured to modify the characteristics of the electrical power received from the power source 534. For example, the controller 535 may be configured to reduce (e.g., throttle) the electrical power that is received from the power source 534 such that the electrical power output by the electrical outlet 532 is less than the electrical power that is received from the power source 534. As another example, the controller 535 may be configured to modify (e.g., transform) the amperage and voltage of the electrical power that is received from the power source 534 such that the amperage and voltage of the electrical power that is output by the electrical outlet 532 is different than the amperage and voltage of the electrical power that is received from the power source 534. In some implementations, the controller 535 may be configured to monitor a power output of the electrical outlet 532 to determine how much electrical power has been consumed while charging the vehicle 100. Furthermore, in some implementations, the connected private property 242 may include a timing device for monitoring a temporal duration with which the vehicle 100 is connected to the electrical outlet 532 (e.g., receiving power from the electrical outlet 532) and/or is present on the connected private property 242.

The transceiver 536 may be configured to send and receive signals 537 to and from, for example, the vehicle 100 (e.g., the control system 108 of the vehicle 100 or some other system of the vehicle 100), another device, and/or other components of the connected private property 242 such that the connected private property 242 may wirelessly communicate with the vehicle 100 (e.g., the control system 108 of the vehicle), other device, and/or other components of the connected private property 242.

The electrical outlet 532 may have a certain geometry (e.g., may have a certain electrical outlet type). For example, as shown, the electrical outlet 532 may be a NEMA 5-15-type electrical outlet 532a, a NEMA 5-20-type electrical outlet 532b, a NEMA TT-30-type electrical outlet 532c, a NEMA 6-30-type electrical outlet 532d, a NEMA 6-50-type electrical outlet 532e, a NEMA 14-50-type electrical outlet 532f, a NEMA 14-30-type electrical outlet 532g, or some other type of electrical outlet. The geometry of the electrical outlet 532 may relate to a rated power output for the electrical outlet 532. For example, the geometry of the electrical outlet 532 may relate to whether the electrical outlet 532 is Level 1 infrastructure, Level 2 infrastructure, or DC Fast Charger infrastructure.

More specifically, the geometry of the electrical outlet 532 may relate to a specific voltage at which the electrical outlet 532 operates and the specific amperage that may be output by the electrical outlet 532. For example, the NEMA 5-15-type electrical outlet 532a may operate at about 125V and may be capable of outputting up to 15 A of current, resulting in a rated power output of about 1.9 kW (e.g., may be Level 1 infrastructure). As another example, the NEMA 5-20-type electrical outlet 532b may also operate at about 125V and may be capable of outputting up to 20 A of current, resulting in a rated power output of about 2.5 kW (e.g., may be Level 1 infrastructure). As another example, the NEMA TT-30-type electrical outlet 532c may operate at 120V and be capable of outputting up to 30 A of current, resulting in a rated power output of about 3.6 kW (e.g., may be Level 1 infrastructure). As another example, the NEMA 6-30-type electrical outlet 532d may operate at about 250V and be capable of outputting up to 30 A of power, resulting in a rated power output of about 7.5 kW (e.g., may be Level 2 infrastructure). As another example, the NEMA 6-50-type electrical outlet 532e may also operate at 250V and be capable of outputting up to 50 A of current, resulting in a rated power output of about 12.5 kW (e.g., may be Level 2 infrastructure). As another example, the NEMA 14-50-type electrical outlet 532f may operate at either about 125V or about 250V and be capable of outputting up to 50 A of current, resulting in a rated power output of between about 6.3 kW and 12.5 kW (may be either Level 1 or Level 2 infrastructure). As another example, the NEMA 14-30-type electrical outlet 532g may also operate at either about 125V or about 250V and be capable of outputting up to 30 A of current, resulting in a rated power output of between about 3.8 kW and 7.5 kW (e.g., may be either Level 1 or Level 2 infrastructure).

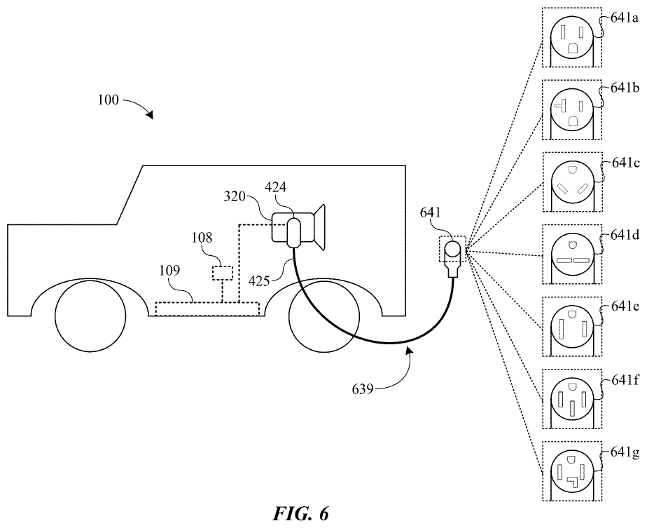

FIG. 6 is a side view illustration of the vehicle 100 that is connected to a portable charger 639. In the illustrated implementation, the vehicle 100 is an EV and thus includes the one or more batteries 109 and the control system 108. As shown, the portable charger 639 is electrically connected to the one or more batteries 109 via the charging inlet 321 (occluded by the charging connector 424 of the portable charger 639) such that the portable charger 639 may facilitate charging (e.g., recharging) of the one or more batteries 109 by, for example, electrically connecting to charging infrastructure (e.g., the electrical outlet 532 shown in FIG. 5). As shown, the portable charger 639 includes the charging connector 424 and the cable 425 as described with respect to FIG. 4. The portable charger 639 also includes an electrical plug 641 that is configured to interface with the electrical outlet 532.

The electrical plug 641 may have a certain geometry (e.g., may have a certain electrical plug type). For example, as shown, the electrical plug 641 may be a NEMA 5-15-type electrical plug 641a, a NEMA 5-20-type electrical plug 641b, a NEMA TT-30-type electrical plug 641c, a NEMA 6-30-type electrical plug 641d, a NEMA 6-50-type electrical plug 641e, a NEMA 14-50-type electrical plug 641f, a NEMA 14-30-type electrical plug 641g, or some other type of electrical outlet.

Types of the electrical plug 641 may be compatible with some types of the electrical outlet 532 and incompatible with other types of the electrical outlet 532. For example, the NEMA 5-15-type electrical plug 641a may be compatible with (e.g., releasably receivable by) the NEMA 5-15-type electrical outlet 532a, and may not be compatible with (e.g., releasably receivable by) other types of the electrical outlet 532. As another example, the NEMA 5-20-type electrical plug 641b may be compatible with (e.g., releasably receivable by) the NEMA 5-20-type electrical outlet 532b, and may not be compatible with (e.g., releasably receivable by) other types of the electrical outlet 532. As another example, the NEMA TT-30-type electrical plug 641c may be compatible with (e.g., releasably receivable by) the NEMA TT-30-type electrical outlet 532c, and may not be compatible with (e.g., releasably receivable by) other types of the electrical outlet 532. As another example, the NEMA 6-30-type electrical plug 641d may be compatible with (e.g., releasably receivable by) the NEMA 6-30-type electrical outlet 532d, and may not be compatible with (e.g., releasably receivable by) other types of the electrical outlet 532. As another example, the NEMA 6-50-type electrical plug 641e may be compatible with (e.g., releasably receivable by) the NEMA 6-50-type electrical outlet 532e, and may not be compatible with (e.g., releasably receivable by) other types of the electrical outlet 532. As another example, the NEMA 14-50-type electrical plug 641f may be compatible with (e.g., releasably receivable by) the NEMA 14-50-type electrical outlet 532f, and may not be compatible with (e.g., releasably receivable by) other types of the electrical outlet 532. As another example, the NEMA 14-30-type electrical plug 641g may be compatible with (e.g., releasably receivable by) the NEMA 14-30-type electrical outlet 532g, and may not be compatible with (e.g., releasably receivable by) other types of the electrical outlet 532.

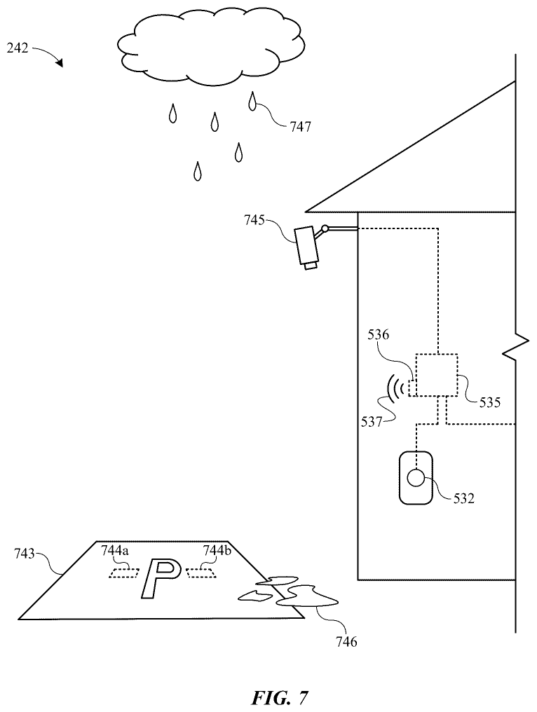

FIG. 7 is a side view illustration of another example of charging infrastructure, and more specifically, another example of the connected private property 242. The connected private property 242 shown in FIG. 7 may be substantially similar to the connected private property 242 described with respect to FIG. 5 except as described herein. For example, the connected private property 242 includes the electrical outlet 532, the controller 535, and the transceiver 536. The connected private property 242 shown in FIG. 7 also includes a parking space 743, sensors 744, and a camera 745. The controller 535 may communicate with the sensors 744 and/or the camera 745 wirelessly via the transceiver 536 or via a wired connection.

The parking space 743 may be a location on which the vehicle 100 may park while using the connected private property 242 for charging. As shown, in some implementations, the parking space 743 may include one or more sensors 744 that are configured to detect whether the vehicle 100 is currently located over the parking space 743. In some implementations, the controller 535 may be configured to process (e.g., interpret) the signal received by the one or more sensors 744, determine control operations based on the signal, and send the control operations to one or more components of the connected private property 242. For example, upon the vehicle 100 driving upon the parking space 743, the sensors 744 may detect that the vehicle 100 is present and send a signal to the controller 535. The controller 535 may process the signal, determine control operations for the camera 745 based on the signal, and send the control operations to cause the camera to capture images (e.g., of the vehicle 100 on the parking space 743).

The camera 745 may be configured to capture images of the vehicle 100, the parking space 743, and/or the electrical outlet 532. In some implementations, the controller 535 may be configured to process (e.g., interpret) the images captured by the camera 745, determine control operations based on the images, and send the control operations to one or more components of the connected private property 242. In some implementations, the camera 745 may capture images interpretable by the controller 535 to indicate that there is water 746 present on or near the parking space 743 and/or on or near the electrical outlet 532 caused by, for example, precipitation 747. For example, the camera 745 may send data indicative of images to the controller 535. The controller 535 may process the data and determine a control operation for the electrical outlet 532 based on whether the controller 535 determines that the water 746 is present. If, for example, the controller 535 determines that the water 746 is present, the controller may send the control operation to components of the connected private property 242 to inhibit (e.g., prevent) the electrical outlet 532 from outputting electrical power. In some implementations, the controller 535 may be operable to communicate with third party applications (e.g., a third party applications running on a device (guest device and/or host device described below) to access weather information for the connected private property 242 (e.g., the geographic region 212). It will be understood that all functionality described with respect to the controller 535 for the connected private property 242 may also be operable by the controller 428 of the charging station 422.

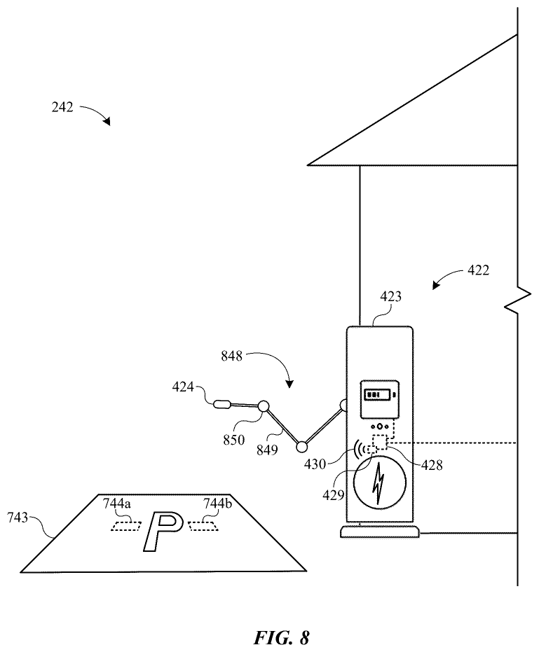

FIG. 8 is a side view illustration of another example of charging infrastructure, and more specifically, another example of the connected private property 242. The connected private property 242 shown in FIG. 8 may be substantially similar to the connected private property 242 described with respect to FIG. 7, except as described herein. For example, the connected private property 242 includes the parking space 743 and the sensors 744. However, rather than including the electrical outlet 532, the connected private property 242 shown in FIG. 8 includes an example of the charging station 422.

The charging station 422 may be substantially similar to the charging station 422 described with respect to FIG. 4 except as described herein. For example, the charging station 422 includes the charging station body 423, the charging connector 424, the controller 428, and the transceiver 429. However, rather than the cable 425 electrically connecting the charging connector 424 to the charging station body 423, the charging station 422 includes an articulating arm 848 that is moveable (e.g., automatically moveable) via, for example, the controller 428. The articulating arm 848 may include one or more linkages 849 (e.g., three of the linkages 849) that are connected via one or more joints 850 (e.g., three of the joints 850).

Similar to the controller 535 described with respect to FIG. 7, the controller 428 may be configured to process (e.g., interpret) the signal received by the one or more sensors 744, determine control operations based on the signal, and send the control operations to one or more components of the connected private property 242 (e.g., the charging station 422 or components thereof). For example, upon the vehicle 100 driving upon the parking space 743, the sensors 744 may detect that the vehicle 100 is present and send a signal to the controller 428. The controller 428 may process the signal, determine control operations for the charging station 422 based on the signal, and send the control operations to cause the articulating arm 848 to connect the charging connector 424 to the charging inlet 321 (see FIG. 3) of the vehicle 100 and, in some implementations, cause the charging station 422 to output electrical power to charge the vehicle 100.

In some implementations, the connected private property 242 and/or the charging station 422 may include other sensors (e.g., the camera 745 described with respect to FIG. 7) that are operable to detect the location of the charging inlet 321 on the vehicle 100. For example, the other sensors (e.g., the camera 745) may send data indicative of images to the controller 428. The controller 428 may process the data, determine a control operation for the charging station 422 based on the location of the charging inlet 321, and send the control signal to cause the articulating arm 848 to move (e.g., articulate via the linkages 849 and the joints 850) such that the charging connector 424 targets the location of the charging inlet 321. In some implementations, the other sensors (e.g., the camera 745 described with respect to FIG. 7) may be operable to detect a vehicle identification number (VIN) for the vehicle 100, which may be used (e.g., by the controller 428) to determine information about the vehicle 100 (e.g., a make and model for the vehicle 100, the rated power input for the vehicle 100, the location of the charging inlet 321 relative to the vehicle body 101 of the vehicle 100, etc.).

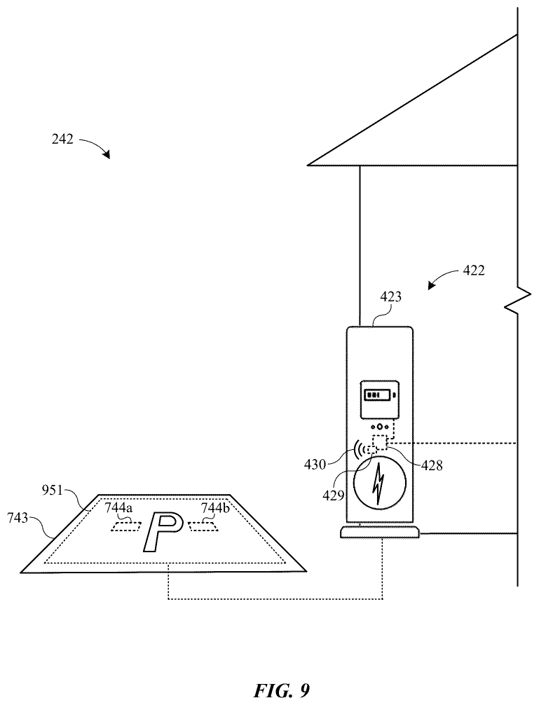

FIG. 9 is a side view illustration of another example of charging infrastructure, and more specifically, another example of the connected private property 242. The connected private property 242 shown in FIG. 9 may be substantially similar to the connected private property 242 described with respect to FIG. 8, except as described herein. For example, the connected private property 242 includes the parking space 743 and the sensors 744. Rather than the articulating arm 848 electrically connecting the charging connector 424 to the charging station body 423, the connected private property 242 includes a wireless charging pad 951 that is configured to wirelessly charge the vehicle 100 (e.g., the one or more batteries 109 of the vehicle 100). The wireless charging pad 951 may be integrated with (e.g., embedded in) the parking space 743. In some implementations, the wireless charging pad 951 may be positioned above or below the parking space 743 (e.g., asphalt that may form the parking space 743).

As described with respect to FIG. 8, the controller 428 may be configured to process (e.g., interpret) the signal received by the one or more sensors 744, determine control operations based on the signal, and send the control operations to one or more components of the connected private property 242 (e.g., the wireless charging pad 951, the charging station 422, or components thereof). For example, upon the vehicle 100 driving upon the parking space 743, the sensors 744 may detect that the vehicle 100 is present and send a signal to the controller 428. The controller 428 may process the signal, determine control operations based on the signal, and send the control operations to cause the charging station 422 to output electrical power to the wireless charging pad 951 to wirelessly charge the vehicle 100 (e.g., the one or more batteries 109 of the vehicle 100).

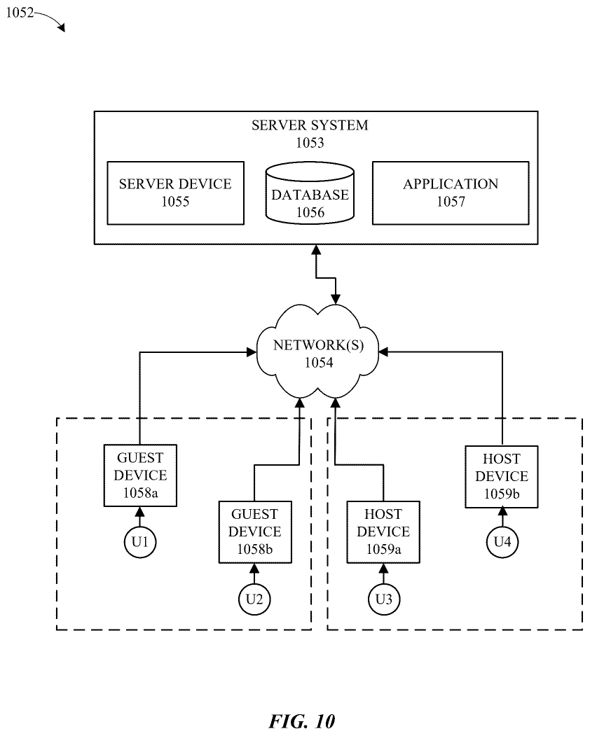

FIG. 10 illustrates a block diagram of an example network environment 1052 that may be used, for example, to implement systems and methods for matching charging infrastructure (e.g., the connected private property 242) to an EV (e.g., the vehicle 100) based on the properties (e.g., capabilities and requirements) of the EV and the charging infrastructure. The systems and methods described may be implemented with the components and/or the charging infrastructure described with respect to FIGS. 1-9. For example, the network environment 1052 described herein may include devices operable to communicate with the control system 108 of the vehicle 100, the controller 428 of the charging station 422, and/or the controller 535 of the connected private property 242 described with respect to FIG. 5 to, for example, control operations of the vehicle 100, the charging station 422, the connected private property 242, and/or components thereof.

Furthermore, the systems and methods that may be implemented with the network environment 1052 may be operable to match vehicles (e.g., the vehicle 100) to charging infrastructure (or vice versa) such that potentially dangerous charging scenarios (e.g., charging scenarios between the vehicle 100 and incompatible charging infrastructure) may be avoided and/or prevented. For example, the systems and methods that may be implemented with the network environment 1052 may be operable to automatically select and schedule the connected private property 242 for charging the vehicle 100 based on the properties of the vehicle 100 (e.g., the rated power input, the geometry of the charging inlet 321, etc.), the properties of the portable charger 639 (e.g., the geometry of the charging connector 424 and/or the electrical plug 641, etc.), and/or the properties of the charging infrastructure (e.g., the rated power output, the geometry of the charging connector 424, etc.).

As used herein, a guest refers to a person associated with a vehicle (e.g., the vehicle 100). For example, a guest may be a driver or passenger of an EV. As used herein, a host refers to a person associated with connected private property. For example, a host may be an owner and/or holder of the connected private property 242. As described previously, incompatibility between EVs and charging infrastructure and the resulting risk of damage to the EV and/or to the charging and/or the resulting safety risk to persons near the EV and/or the charging infrastructure may lead hosts (e.g., owners or holders of connected private properties) to be hesitant to grant guests permission to charge their vehicle on the connected private property 242 of the host. Accordingly, by providing systems and methods for safely and reliably matching EVs to charging infrastructure, hosts may be more likely to grant guests permission to charge their vehicle on the connected private property 242 of the host. Thus, because between about 70% and 80% of charging infrastructure in a given geographic region is included on residential properties (e.g., the residential properties 217) and between about 5% and 10% of charging infrastructure in a given geographic region is included on commercial properties (e.g., the commercial properties 218), the availability of charging infrastructure may increase (e.g., may substantially increase) as a result of such systems and methods. Furthermore, the systems and methods that may be implemented with the network environment 1052 may provide the hosts opportunities for marketing and sale of charging infrastructure use.

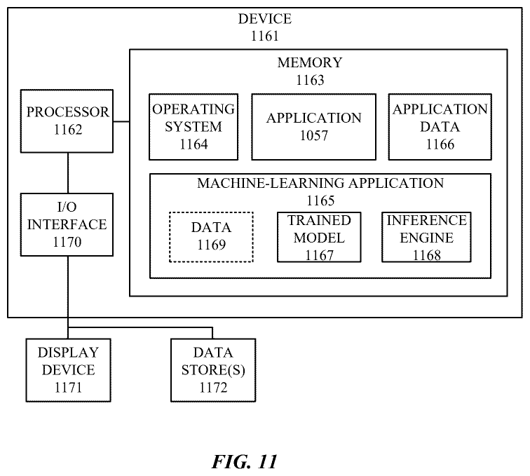

As described in further detail herein, the systems and methods that may be implemented with the network environment 1052 may be operable to predict which charging infrastructure a guest is likely to select based on certain requirements of the vehicle 100, certain preferences of the guest, and other factors. To make predictions, a probabilistic model (or other model as described below in conjunction with FIG. 11) may be used to make a prediction (e.g., an inference) about which charging infrastructure the guest is likely to select. Other aspects may be predicted as described below. In some implementations, the systems and methods that may be implemented with the network environment 1052 may include a mobile application, a web application, or other type of application assessable to a host and/or a guest.

The network environment 1052 may include one or more server systems such as, for example, a server system 1053. The server system 1053 may, for example, be configured to communicate with a network 1054. The server system 1053 may include a server device 1055, a database 1056 or other data store or data storage device, and an application 1057. The network environment 1052 may also include one or more guest devices 1058 such as, for example, a guest device 1058a and a guest device 1058b. The guest devices 1058 may be associated with (e.g., usable by) respective users (e.g., U1, U2) associated with a vehicle (e.g., the vehicle 100). For example, the guest devices 1058 may be associated with a driver of an EV that may require recharging. Although two of the guest devices 1058 are shown, any number of the guest devices 1058 may be included with the network environment 1052 (e.g., 50 of the guest devices 1058, 100 of the guest devices 1058, 1,000 of the guest devices 1058, 100,000 of the guest devices 1058). The network environment 1052 may also include one or more host devices 1059 such as, for example, a host device 1059a and a host device 1059b. The host devices 1059 may be associated with (e.g., usable by) respective users (e.g., U3, U4) associated with connected private property (e.g., the connected private property 242). Although two of the host devices 1059 are shown, any number of the host devices 1059 may be included with the network environment 1052 (e.g., 50 of the host devices 1059, 100 of the host devices 1059, 1,000 of the host devices 1059, 100,000 of the host devices 1059).

The guest devices 1058 and the host devices 1059 may communicate with each other and/or with the server system 1053 via, for example, the network 1054. The network 1054 may be any type of communication network, including one or more of the Internet, local area networks (LAN), wireless networks, switch or hub connections, etc. In some implementations, the network 1054 may include peer-to-peer communication between devices (e.g., between the guest devices 1058, between the host devices 1059, and/or between one or more of the guest devices 1058 and one or more of the host devices 1059). Peer-to-peer communication between devices may, for example, be executed using peer-to-peer wireless protocols (e.g., Bluetooth®, Wi-Fi Direct, etc.). In some implementations, the network 1054 may include communication between the guest devices 1058, the host devices 1059, the server device 1055, the control system 108 of the vehicle 100 (see FIG. 1), the controller 428 of the charging station 422 (see FIG. 4), and/or the controller 535 of the connected private property 242 (see FIG. 5). In some implementations, some of the communication between the guest devices 1058, the host devices 1059, the server device 1055, the control system 108 of the vehicle 100, the controller 428 of the charging station 422, and/or the controller 535 of the connected private property 242, may be implemented using peer-to-peer wireless protocols while communication between other of these devices may be implemented via the network 1054.

In some implementations, the application 1057 (or portions thereof) may be implemented (e.g., installed) on the guest devices 1058 and/or the host devices 1059 or may be implemented with the server system 1053 and accessible by the guest devices 1058 and/or the host devices 1059 via the network 1054. For example, as described in greater detail below, the application 1057 may be accessed through the guest device 1058 to provide inputs usable to match an associated vehicle (e.g., the vehicle 100) to compatible charging infrastructure. As another example, the application 1057 may be accessed through the host device 1059 to provide inputs usable to match associated charging infrastructure (e.g., the connected private property 242) to EVs. The application 1057 may also facilitate adding new users, storing reviews, and other operations of the systems and methods described herein. In implementations where the application 1057 (or portions thereof) are implemented with the server system 1053, the server system 1053 may aid in facilitating the operations of the systems and methods described herein.

The guest devices 1058 and the host devices 1059 may have any suitable form factor. For example, the guest devices 1058 and the host devices 1059 may be mobile phone devices, tablets, laptop computers, or the like. In some implementations, the guest device 1058 may be integrated with systems of the vehicle 100 (e.g., the guest device 1058 may be the vehicle 100). For example, the guest device 1058 may be an infotainment system of the vehicle 100. Where the guest device 1058 is integrated with systems of the vehicle 100 and includes the application 1057 (or portions thereof), the application 1057 may have access (e.g., limited access) to the systems of the vehicle 100 such as, for example, the control system 108 and a BCM of the vehicle 100. For example, the application 1057 may have read-only access to the BCM of the control system 108 of the vehicle 100 to monitor the status of the one or more batteries 109 (e.g., to monitor the charge level 111 of the one or more batteries 109). In some implementations, the application 1057 (or portions thereof) may be integrated with systems of the vehicle 100 as a third-party application.

For clarity purposes, FIG. 10 illustrates one block for the server system 1053, the server device 1055, and the database 1056, illustrates two blocks for the guest devices 1058, and illustrates two blocks for the host devices 1059. However, some blocks may represent multiple systems, server, device, and network databases, and the blocks may be provided in different configurations than as illustrated. For example, the server system 1053 may represent multiple server systems that may communicate with other systems via the network 1054. In some implementations, the database 1056 and/or other storage devices may be provided in server systems block(s) that are separate from the server device 1055 and may communicate with the server device 1055 and other server systems via the network 1054. Furthermore, as described above, there may be any number of the guest devices 1058 and any number of the host devices 1059. In some implementations, the network 1054 may not include all of the components illustrated in FIG. 10 and/or may include other types of elements instead of, or in addition to, those described herein.

In some implementations, the guests (e.g., U1, U2) and the hosts (e.g., U3, U4) may communicate with the server system 1053 and/or each other using respective ones of the guest devices 1058 and the host devices 1059. For example, the guests (e.g., U1, U2) and the hosts (e.g., U3, U4) may interact with each other via the application 1057 (or portions thereof) running on respective ones of the guest devices 1058, the host devices 1059, the server system 1053, and/or via a network service (e.g., an image sharing service, a messaging service, a social network service or other type of network service implemented on the server system 1053). In some implementations, the server system 1053 may provide appropriate data to the guest devices 1058 and/or the host devices 1059 such that each of the guest devices 1058 and/or the host devices 1059 may receive communicated content or shared content uploaded to the server system 1053 and/or other network service. Furthermore, in some implementations, one or more hosts and/or one or more guests may include one or more programs or virtual entities, as well as persons that interface with the system or network. For example, where the vehicle 100 includes autonomous driving functionality, the guest associated with the vehicle 100 may be a virtual entity.

FIG. 11 is a block diagram of an example device 1161 which may be used to implement one or more features described herein. In one example, device 1161 may be used to implement one or more of the guest devices 1058 and/or the host devices 1059 (e.g., the device 1161 may be one or more of the guest devices 1058 and/or one or more of the host devices 1059). Alternatively, or in addition, the device 1161 may be used to implement the server device 1055 (e.g., the device 1161 may be the server device 1055). In some implementations, the device 1161 may be used to implement some or all of the guest devices 1058, some or all of the host devices 1059, the server device 1055, or a combination thereof. The device 1161 may be any suitable computer system, server, or other electronic or hardware device as described above.

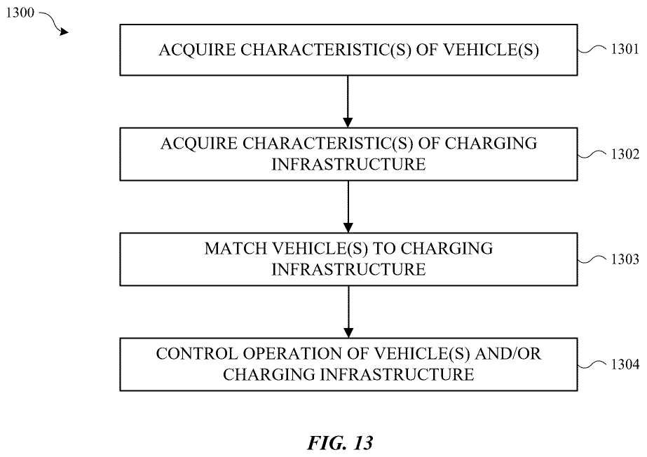

One or more methods described herein (e.g., as shown in FIGS. 13-16 and 18) may be run in a standalone program that may be executed on any type of computing device, a program run on a web browser, the application 1057 run on a mobile computing device (e.g., the guest devices 1058, the host devices 1059, etc.).

In some implementations a client/server architecture may be used, e.g., a mobile computing device (e.g., as the guest device 1058 and/or the host device 1059) sends user input data to the server device 1055 and receives from the server system 1053 the final output data for output (e.g., for controlling an operation of the vehicle 100, the charging station 422, and/or the connected private property 242). In another example, all computations may be performed within the mobile app (and/or other apps) on the mobile computing device. In another example, computations may be split between the mobile computing device and one or more server devices.

In some implementations, the device 1161 may include one or more processors 1162, one or more memories 1163, and one or more I/O interfaces 1170. The one or more processors 1162 may be one or more processing circuits that are configured to execute program code and control basic operations of the device 1161. The one or more processors 1162 may include any suitable hardware system, mechanism or component that processes data, signals or other information. The one or more processors 1162 may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, each of the one or more processors 1162 may include one or more co-processors that are configured to implement neural-network processing. In some implementations, the one or more processors 1162 may be one or more processors that process data to produce probabilistic output, e.g., the output produced by the one or more processors 1162 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. As described herein, a computer may be any processor that is in communication with a memory.

The one or more memories 1163 may be provided in the device 1161 for access by the one or more processors 1162 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from the one or more processors 1162 and/or integrated therewith. The one or more memories 1163 may store software operating on the server device 1055, including an operating system 1164, a machine-learning application 1165, the application 1057 (or portions thereof), and application data 1166. Other applications may include applications such as a data display engine, web hosting engine, image display engine, notification engine, social networking engine, etc. In some implementations, the machine-learning application 1165 and the application 1057 may each include instructions that enable the one or more processors 1162 to perform functions described herein (e.g., some or all of the methods of FIGS. 13-16 and 18).

The machine-learning application 1165 may include one or more NER implementations for which supervised and/or unsupervised learning may be used. The machine learning models may include multi-task learning based models, residual task bidirectional LSTM (long short-term memory) with conditional random fields, statistical NER, etc. In various implementations, machine-learning application 1165 may utilize Bayesian classifiers, support vector machines, neural networks, or other learning techniques. In some implementations, the machine-learning application 1165 may include a trained model 1167, an inference engine 1168, and data 1169. In some implementations, the data 1169 may include training data (e.g., data used to generate the trained model 1167). For example, training data may include any type of data suitable for training a model for the systems and methods described herein, such as images of charger connectors or electrical outlets (charging inlets), charger hosting and/or guest data, review information, labels, thresholds, etc. associated EV charging tasks described herein. Training data may be obtained from any source, e.g., a data repository specifically marked for training, data for which permission is provided for use as training data for machine-learning, etc. In implementations where one or more users permit use of their respective user data to train a machine-learning model (e.g., trained model 1167) training data may include such user data. In implementations where users permit use of their respective user data, the data 1169 may include permitted data.

In some implementations, the data 1169 may include collected data such as previous charging matching, reservations, and/or reviews. In some implementations, training data may include synthetic data generated for the purpose of training, such as data that is not based on user input or activity in the context that is being trained, e.g., data generated from simulated conversations, computer-generated images, etc. In some implementations, the training data may include images of charging connectors, charging inlets, electrical plugs, and electrical outlets such that the AI/ML model may be trained to utilize computer vision to assess images shared by host to confirm host description of charging asset and to match EVs to most relevant and most proximate available charging resources. In some implementations, the machine-learning application 1165 excludes some of the data 1169. For example, in these implementations, the trained model 1167 may be generated (e.g., on a different device) and be provided as part of the machine-learning application 1165. In various implementations, the trained model 1167 may be provided as a data file that includes a model structure or form, and associated weights. Inference engine 1168 may read the data file for trained model 1167 and implement a neural network with node connectivity, layers, and weights based on the model structure or form specified in trained model 1167.

In some implementations, the trained model 1167 may include one or more model forms or structures. For example, model forms or structures may include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as the data 1169 or the application data 1166. Such data may include, for example, images. Subsequent intermediate layers may receive as input output of nodes of a previous layer per the connectivity specified in the model form or structure. These layers may also be referred to as hidden layers. A final layer (e.g., output layer) produces an output of the machine-learning application. In some implementations, model form or structure also specifies a number and/or type of nodes in each layer.

In some implementations, the trained model 1167 may include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, the trained model 1167 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using the data 1169, to produce a result.

For example, training may include applying supervised learning techniques. In supervised learning, the training data may include a plurality of inputs (e.g., EV charging data) and a corresponding expected output for each input. Based on a comparison of the output of the model with the expected output, values of the weights are automatically adjusted, e.g., in a manner that increases the probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner.

In some implementations, a model trained using unsupervised learning may cluster words based on the use of the words in data sources. In some implementations, unsupervised learning may be used to produce knowledge representations, e.g., that may be used by machine-learning application 1165. In various implementations, a trained model includes a set of weights, or embeddings, corresponding to the model structure. In implementations where data 1169 is omitted, machine-learning application 1165 may include trained model 1167 that is based on prior training, e.g., by a developer of the machine-learning application 1165, by a third-party, etc. In some implementations, trained model 1167 may include a set of weights that are fixed, e.g., downloaded from a server that provides the weights.

The inference engine 1168 is configured to apply the trained model 1167 to data, such as application data 1166, to provide an inference. In some implementations, inference engine 1168 may include software code to be executed by the one or more processors 1162. In some implementations, inference engine 1168 may specify circuit configuration (e.g., for a programmable processor, for a field programmable gate array (FPGA), etc.) enabling the one or more processors 1162 to apply the trained model. In some implementations, inference engine 1168 may include software instructions, hardware instructions, or a combination. In some implementations, inference engine 1168 may offer an application programming interface (API) that may be used by the operating system 1164 and/or the application 1057 to invoke the inference engine 1168, e.g., to apply the trained model 1167 to application data 1166 to generate an inference.

The machine-learning application 1165 may provide several technical advantages. For example, when the trained model 1167 is generated based on unsupervised learning, the trained model 1167 may be applied by the inference engine 1168 to produce knowledge representations (e.g., numeric representations) from input data, e.g., the application data 1166. For example, a model trained for EV charging tasks may produce predictions and confidences for given input information about EV charging. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of the inference engine 1168.

In some implementations, knowledge representations generated by the machine-learning application 1165 may be provided to a different device that conducts further processing, e.g., over a network. In such implementations, providing the knowledge representations rather than the images may provide a technical benefit, e.g., enable faster data transmission with reduced cost.

In some implementations, the machine-learning application 1165 may be implemented in an offline manner. In these implementations, the trained model 1167 may be generated in a first stage and provided as part of the machine-learning application 1165. In some implementations, the machine-learning application 1165 may be implemented in an online manner. For example, in such implementations, an application that invokes the machine-learning application 1165 (e.g., the operating system 1164, the application 1057 or other applications) may utilize an inference produced by the machine-learning application 1165, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update the trained model 1167, e.g., to update embeddings for the trained model 1167.

In some implementations, the machine-learning application 1165 may be implemented in a manner that may adapt to particular configuration of the device 1161 on which the machine-learning application 1165 is executed. For example, the machine-learning application 1165 may determine a computational graph that utilizes available computational resources, e.g., the one or more processors 1162. For example, if the machine-learning application 1165 is implemented as a distributed application on multiple devices, the machine-learning application 1165 may determine computations to be carried out on individual devices in a manner that optimizes computation. In another example, the machine-learning application 1165 may determine that the one or more processors 1162 includes a GPU with a particular number of GPU cores (e.g., 1000) and implement the inference engine accordingly (e.g., as 1000 individual processes or threads).

In some implementations, the machine-learning application 1165 may implement an ensemble of trained models. For example, the trained model 1167 may include a plurality of trained models that are each applicable to the same input data. In these implementations, the machine-learning application 1165 may choose a particular trained model, e.g., based on available computational resources, success rate with prior inferences, etc. In some implementations, the machine-learning application 1165 may execute the inference engine 1168 such that a plurality of trained models is applied. In these implementations, the machine-learning application 1165 may combine outputs from applying individual models, e.g., using a voting-technique that scores individual outputs from applying each trained model, or by choosing one or more particular outputs. Further, in these implementations, machine-learning applications may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by the operating system 1164 or one or more other applications, e.g., the application 1057.

In different implementations, the machine-learning application 1165 may produce different types of outputs. For example, the machine-learning application 1165 may provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, the machine-learning application 1165 may produce an output video with a particular effect applied, e.g., rendered in a comic-book or particular artist's style, when the trained model 1167 is trained using training data from the comic book or particular artist, etc. In some implementations, the machine-learning application 1165 may produce an output based on a format specified by an invoking application, e.g., the operating system 1164 or one or more applications, e.g., the application 1057. In some implementations, an invoking application may be another machine-learning application. For example, such configurations may be used in generative adversarial networks, where an invoking machine-learning application is trained using output from the machine-learning application 1165 and vice-versa.

Any software in the one or more memories 1163 may alternatively be stored in any other suitable storage location or computer-readable medium. In addition, the one or more memories 1163 (and/or other connected storage device(s)) may store one or more messages, one or more taxonomies, electronic encyclopedia, dictionaries, thesauruses, knowledge bases, message data, grammars, user preferences, and/or other instructions and data used in the features described herein. The one or more memories 1163 and any other type of storage (magnetic disk, optical disk, magnetic tape, or other tangible media) may be considered “storage” or “storage devices.”

The I/O interface 1170 may provide functions to enable interfacing the server device 1055 with other systems and devices. Interfaced devices may be included as part of the device 1161 or may be separate and communicate with the device 1161. For example, network communication devices, storage devices (e.g., memory and/or database 1056), and input/output devices may communicate via the I/O interface 1170. In some implementations, the I/O interface 1170 may connect to interface devices such as input devices (keyboard, pointing device, touchscreen, microphone, camera, scanner, sensors, etc.) and/or output devices (display devices, speaker devices, printers, motors, etc.).

Some examples of interfaced devices that may connect to the I/O interface 1170 may include one or more display devices 1171 and one or more data stores 1172 (as discussed above). The display devices 1171 that may be used to display content, e.g., a user interface of an output application as described herein. The display device 1171 may be connected to the device 1161 via local connections (e.g., display bus) and/or via networked connections and may be any suitable display device. The display device 1171 may include any suitable display device such as an LCD, LED, or plasma display screen, CRT, television, monitor, touchscreen, 3-D display screen, or other visual display device. For example, the display device 1171 may be a flat display screen provided on a mobile device, multiple display screens provided in a goggles or headset device, or a monitor screen for a computer device.

The I/O interface 1170 may interface to other input and output devices. Some examples include one or more cameras which may capture images, including charging connector, charging inlet, and Vehicle Identification Number (VIN) images. Some implementations may provide a microphone for capturing sound (e.g., as a part of captured images, voice commands, etc.), audio speaker devices for outputting sound, or other input and output devices.

For ease of illustration, FIG. 11 illustrates one block for the one or more processors 1162, the one or more memories 1163, the I/O interface 1170, the operating system 1164, the application 1057, and machine-learning application 1165. These blocks may represent one or more processors or processing circuitries, operating systems, memories, I/O interfaces, applications, and/or software modules. In other implementations, the device 1161 may not include all of the components shown and/or may have other elements including other types of elements instead of, or in addition to, those shown herein. While some components are described as performing blocks and operations as described in some implementations herein, any suitable component or combination of components of the network environment 1052, the device 1161, similar systems, or any suitable processor or processors associated with such a system, may perform the blocks and operations described.

In some implementations, logistic regression may be used for personalization. In some implementations, the prediction model may be handcrafted including hand selected labels and thresholds. The mapping (or calibration) from ICA space to a predicted precision within a space may be performed using a piecewise linear model.

In some implementations, the system described herein may include a machine-learning model (as described herein) for tuning the system to potentially provide improved accuracy. Inputs to the machine learning model may include ICA labels, an image descriptor vector that describes appearance and includes semantic information about peer-to-peer EV charging devices and infrastructure. Example machine-learning model input may include labels for a simple implementation and may be augmented with descriptor vector features for a more advanced implementation. Output of the machine-learning module may include a prediction of which charging infrastructure a guest may select to for charging an associated EV (e.g., the vehicle 100).

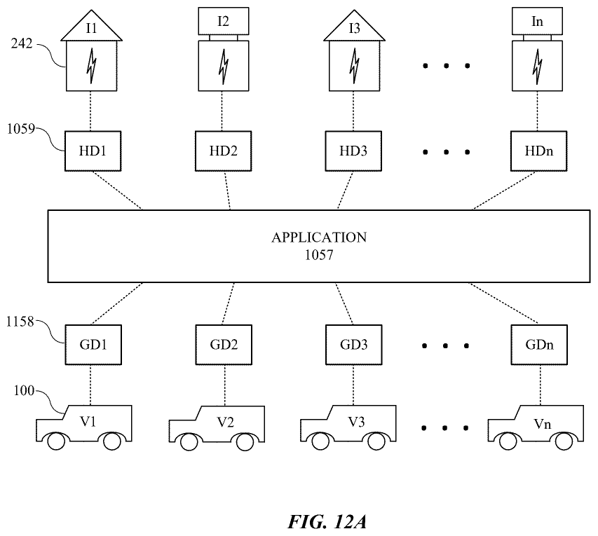

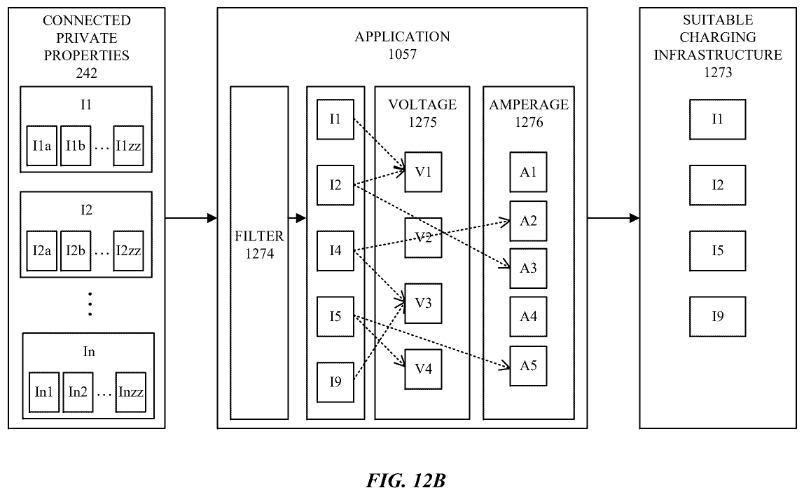

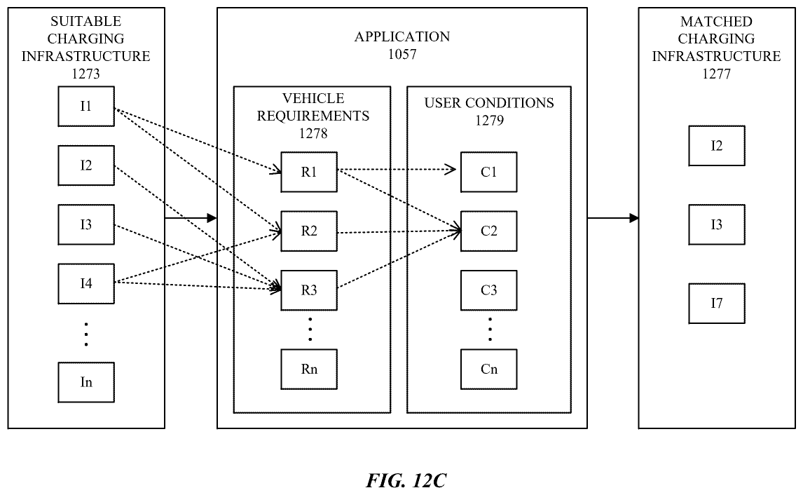

FIGS. 12A-12C are schematic illustrations of the functions that may be performed by, for example, the application 1057 for matching EVs with compatible charging infrastructure. Referring to FIG. 12A, multiple of the connected private properties 242 (e.g., I1, I2, I3, . . . . In) may each be associated with one or more of the host devices 1059 (e.g., HD1, HD2, HD3, HDn). Furthermore, multiple of the vehicles 100 (V1, V2, V3, . . . . Vn) may be associated with one or more guest devices 1058 (e.g., GD1, GD2, GD3, . . . . GDn). As will be explained in more detail below, data indicative of multiple of the connected private properties 242 (e.g., capabilities, requirements, conditions, etc.) may be communicated with the application 1057 and processed to match (e.g., predictively match, automatically match) one or more of the vehicles 100 to the multiple of the connected private properties 242, and/or vice versa.

It will be understood that as used herein, in the context of communication between electronic devices such as, for example, the control system 108, the controller 428, the display 427, the transceiver 429, the electrical outlet 532, the controller 535, the transceiver 536, the sensors 744, the camera 745, the network environment 1052 (and components thereof), and the device 1161 (and components thereof), sending, signaling, receiving, acquiring, obtaining, and/or otherwise communicating information means that the electronic devices are sending, signaling, receiving, acquiring, obtaining, and/or otherwise communicating data indicative of that information. For example, where the charging station 422 is described as sending a geometry of the charging connector 424 to the guest device 1058, rather than sending the actual geometry of the charging connector 424 to the guest device 1058, the charging station 422 sends data indicative of the geometry of the charging connector 424 to the guest device 1058 which may be interpreted by the guest device 1058 (or components or features thereof) to identify the geometry of the charging connector 424.

Referring to FIG. 12B, a process is illustrated by which the connected private properties 242 may be filtered to output suitable charging infrastructure 1273. The suitable charging infrastructure 1273 may be the connected private properties 242 that are generally safe to use with certain EVs depending on the requirements thereof. The process illustrated in FIG. 12B may be implemented when a matching function (e.g., an automatic and/or predictive matching function) is initiated by, for example, the guest device 1058 to match the associated EV (e.g., the vehicle 100) to compatible infrastructure (e.g., a compatible one of the connected private properties 242). Initially, the multiple of the connected private properties 242 (e.g., I1, I2, . . . . In) are input to the application 1057. As shown, each of the connected private properties 242 may include one or more characteristics (e.g., I1a, I1b, . . . . I1zz). Where the connected private properties 242 include the charging station 422, the one or more characteristics of the connected private properties 242 may include, for example, the geometry of the charging connector 424 of the charging station 422, the rated power output of the charging station 422, the operating voltage of the charging station 422, the amperage output capabilities of the charging station 422, whether the charging station 422 includes the cable 425, the articulating arm 848, or is connected to the wireless charging pad 951, and/or other characteristics.

Where the connected private property 242 includes the electrical outlet 532, the one or more characteristics of the connected private property 242 may include, for example, the geometry of the electrical outlet 532, the rated power output of the electrical outlet 532, the operating voltage of the electrical outlet 532, the amperage output capabilities of the electrical outlet 532, whether the electrical outlet 532, and/or other characteristics. The characteristics may also include characteristics of the connected private property 242 and/or the associated host. For example, the characteristics may include the location of the connected private property 242, the present and/or future availability of the connected private property 242 for charging, whether the electrical outlet 532 or the charging station 422 is located outside, the penalty (e.g., cost) to use the connected private property 242, whether the host offers contactless charging, whether there are certain amenities (e.g., restaurants, shops, etc.) near the connected private property 242, whether there is a pet present on the property, whether the property is under surveillance, and/or other characteristics.

Once the connected private properties 242 and the associated characteristics are received by the application 1057, the connected private properties 242 may be filtered based on the associated characteristics by the filter 1274. In some implementations, the filter 1274 will filter out the connected private properties 242 that do not include a geometry for the charging connector 424 and/or the electrical outlet 532 that is suitable for EV charging. For example, the filter 1274 may filter out some or all of the connected private properties 242 that include the electrical outlet 532 but that do not include the NEMA 5-15-type electrical outlet 532a, the NEMA 5-20-type electrical outlet 532b, the NEMA TT-30-type electrical outlet 532c, the NEMA 6-30-type electrical outlet 532d, the NEMA 6-50-type electrical outlet 532e, the NEMA 14-50-type electrical outlet 532f, the NEMA 14-30-type electrical outlet 532g. Additionally or alternatively, the filter 1274 may filter out some or all of the connected private properties 242 that include the electrical outlet 532 but the electrical outlet 532 is ungrounded.

Additionally or alternatively, the filter 1274 may filter out some or all of the connected private properties 242 that include the charging station 422 but that do not include the J1772-type charging connector 424a, the NACS-type charging connector 424b, the CHAdeMO-type charging connector 424c, or the CCS-type charging connector 424d. Additionally or alternatively, the filter 1274 may filter out some or all of the connected private properties 242 that include the charging station 422 but that include a geometry for the charging connector 424 that is not typically associated with the rated power output of the charging station 422 (e.g., the J1772-type charging connector 424a being connected the charging station 422 where the charging station 422 has a rated power output of 350 kW). Additionally or alternatively, the filter 1274 may filter the connected private properties 242 based on some other criteria. In some implementations, the filter 1274 may be independent of the vehicle 100 to which the connected private properties 242 are being matched. Furthermore, in some implementations, the filtering performed by the application 1057 as illustrated in FIG. 12B may be performed locally (e.g., partially locally) on the host device 1059.

The output of the filter 1274 includes the connected private properties 242 that met the filter criteria of the filter 1274 described above (e.g., I1, I2, I4, I5, I9). The output of the filter 1274 is further processed by the application 1057 to determine whether the remaining ones of the connected private properties 242 meet additional criteria. For example, the application 1057 may assess the operating voltage and the amperage output capabilities of the charging station 422 or the electrical outlet 532 against one or more voltages 1275 (e.g., V1, V2, V3, V4) and one or more amperages 1276 (e.g., A1, A2, A3, A4, A5). In some implementations, the one or more voltages 1275 and the one or more amperages 1276 correspond with those of commonly used charging infrastructure. For example, the one or more voltages 1275 may include 120V, 208V, 250V, and 480V, and the one or more amperages 1276 may include 12 A, 16 A, 24 A, 32 A, and 40 A (e.g., corresponding to Level 1, Level 2, and DC Fast Charge infrastructure). Accordingly, by assessing the operating voltage and the amperage output capabilities of the charging station 422 or the electrical outlet 532 against such values, the application 1057 may adjust a maximum current and/or power output and display only the connected private properties 242 that include commonly used charging infrastructure with suitable performance characteristics. In such an implementation, the filtering based on the voltage 1275 and the amperage 1276 values may be independent of the vehicle 100 to which the connected private properties 242 are being matched. Although four of the voltages 1275 and five of the amperages 1276 are illustrated in FIG. 12B, the application 1057 may include any number of the voltages 1275 and/or the amperages 1276.

Once the application 1057 has filtered the connected private properties 242 based on the voltage 1275 and the amperage 1276, and implemented logic to determine a potentially lesser current and power output, depending on the charging device type, that is suitable for sustained electric vehicle charging, the application 1057 may output the suitable charging infrastructure 1273 (e.g., I1, I2, I5, I9) and display adjusted electrical characteristics (current and power) that align with National Electric Code (NAC) guidelines. As described above, the suitable charging infrastructure 1273 may include the connected private properties 242 that include commonly used charging infrastructure. Accordingly, the suitable charging infrastructure 1273 may be generally safe to use with certain EVs depending on the requirements thereof.

Referring to FIG. 12C, a process is illustrated by which the suitable charging infrastructure 1273 may be filtered to output matched charging infrastructure 1277. The matched charging infrastructure 1277 may be the connected private properties 242 that are matched to the specific requirements of the EV (e.g., the rated power input for the one or more batteries 109 of the vehicle 100) and/or conditions (e.g., preferences) for the guest associated with the EV. The process illustrated in FIG. 12C may be implemented once the application 1057 has performed the initial filtering as described with respect to FIG. 12B. Initially, the suitable charging infrastructure 1273 (e.g., I1, I2, I3, I4, . . . . In) is input to the application 1057. Although different ones of the suitable charging infrastructure 1273 are depicted in FIG. 12C than what was output by the application 1057 in FIG. 12B, it will be understood that the output of the application 1057 as depicted in FIG. 12B may be the same as the input to the application 1057 depicted in FIG. 12C.

Once the application 1057 has received the suitable charging infrastructure 1273, the application 1057 may further process the suitable charging infrastructure 1273 to, for example, compare the characteristics of the suitable charging infrastructure 1273 (e.g., the geometry of the charging connector 424 or electrical outlet 532, the rated power output of the charging station 422 or the electrical outlet 532, etc.) against vehicle requirements 1278 (e.g., R1, R2, R3, . . . . Rn) for the vehicle 100 to which the connected private properties 242 are being matched. For example, the vehicle requirements 1278 may include, for example, the geometry of the charging inlet 321, the geometry of the electrical plug 641 of the portable charger 639, and the rated power input for charging the one or more batteries 109. Accordingly, the application 1057 may be operable to filter out some or all of the suitable charging infrastructure 1273 that is not compatible with the vehicle 100 to which the suitable charging infrastructure 1273 (e.g., the connected private properties 242) is being matched. Furthermore, once the application 1057 has received the suitable charging infrastructure 1273, the application may, in addition or alternatively, compare the characteristics of the suitable charging infrastructure 1273 (e.g., the present and/or future availability of the suitable charging infrastructure 1273, whether the host offers contactless charging, etc.) against user conditions 1279 (e.g., C1, C2, C3, . . . . Cn) of the guest associated with the vehicle 100. For example, the user conditions 1279 of the guest associated with the vehicle 100 may include, for example, the present and/or future time that the guest desires to use the suitable charging infrastructure 1273 for charging, a distance to the suitable charging infrastructure 1273 (e.g., a real-time distance to the suitable charging infrastructure 1273, whether the electrical outlet 532 or the charging station 422 is located outside, whether the host offers contactless charging, whether there are certain amenities (e.g., restaurants, shops, etc.) near the suitable charging infrastructure 1273, whether there is a pet present on the property, whether the property is under surveillance, and/or other characteristics.

Once the application 1057 has filtered the suitable charging infrastructure 1273 based on the vehicle requirements 1278 and the user conditions 1279, the application 1057 may output the matched charging infrastructure 1277 (e.g., I1, I2, I5, I9). As described above, the matched charging infrastructure 1277 may include the connected private properties 242 that are matched to the specific requirements of the EV (e.g., the rated power input for the one or more batteries 109 of the vehicle 100) and/or conditions (e.g., preferences) for the guest associated with the EV. Accordingly, the matched charging infrastructure 1277 may have a high probability of being selected by the guest.

FIG. 13 is flowchart of an example of a method 1300 for matching the vehicle 100 with the connected private property 242 (e.g., matching the vehicle 100 with the matched charging infrastructure 1277 as described above) and controlling an operation of the vehicle 100 and/or the connected private property 242 based thereon. The method 1300 may include acquiring 1301 characteristics of the vehicle 100. The characteristics of the vehicle 100 may include, for example, the geometry of the charging inlet 321 and/or the geometry of the electrical plug 641 of the portable charger 639, the rated power input for the charging the one or more batteries 109, the make and/or model of the vehicle 100, historical data related to charging and discharging of the one or more batteries (e.g., historical power consumption data), the range of the vehicle 100 based on the charge level 111 of the one or more batteries, the location of the vehicle 100, and/or other characteristics. The characteristics of the vehicle 100 may also include preferences of the guest associated with the vehicle 100 (e.g., may include the user conditions 1279). For example, the characteristics may include the present and/or future time that the guest desires to use the connected private property 242 for charging, a distance to the connected private property 242 (e.g., a real-time distance to the connected private property 242), whether the electrical outlet 532 or the charging station 422 is located outside, whether the host offers contactless charging, whether there are certain amenities (e.g., restaurants, shops, etc.) near the connected private property 242, whether there is a pet present on the property, whether the property is under surveillance, and/or other characteristics.

In some implementations, the characteristics of the vehicle 100 may be input to the application via the I/O interface 1170 of the guest device 1058. In some implementations, some of the characteristics of the vehicle 100 may be input to the application via the I/O interface 1170 of the guest device 1058 and other characteristics of the vehicle 100 may be inferred based thereon. In some implementations, the characteristics of the vehicle 100 may be automatically input based on one or more images of the vehicle 100 and/or the charging inlet 321 of the vehicle 100 using, for example, an image recognition model (e.g., a machine learning model trained on images of vehicles and/or charging inlets).

The method 1300 may also include acquiring 1302 characteristics of the connected private property 242. The characteristics of the connected private property 242 may be the same as the characteristics of the connected private property 242 described above with respect to FIG. 12B. In some implementations, the characteristics of the connected private property 242 may be input to the application via the I/O interface 1170 of the host device 1059. In some implementations, some of the characteristics of the connected private property 242 may be input to the application via the I/O interface 1170 of the host device 1059 and other characteristics of the connected private property 242 may be inferred based thereon. In some implementations, the characteristics of the connected private property 242 may be automatically input based on one or more images of the charging station 422, the electrical outlet 532 and/or the connected private property 242 using, for example, an image recognition model (e.g., a machine learning model trained on images of charging stations, electrical outlets, and/or other charging infrastructure).

The method 1300 may also include matching 1303 the vehicle 100 to compatible charging infrastructure based on the characteristics of the vehicle 100 and the characteristics of the connected private properties 242. In some implementations, the matching 1303 is performed using the process described above with respect to FIGS. 12A-12C. In some implementations, the vehicle 100 may be matched to one or more of the connected private property 242 based on (e.g., based in part on), for example, the geometry of the charging inlet 321 of the vehicle 100 being compatible with the geometry of the charging connector 424 of the charging station 422 of the one or more of the connected private property 242. The vehicle 100 may be matched to the one or more of the connected private property 242 based on (e.g., based in part on) any of the characteristics of the vehicle 100 being compatible with (e.g., matching) the characteristics of the one or more of the connected private properties 242. In some implementations, the results of the matching may be displayed on the guest device 1058 (e.g., the display device 1171 of the guest device 1058) to be viewable by the guest associated with the vehicle 100. Where more than one of the connected private properties 242 are matched to the vehicle 100, the guest device 1058 may display some or all of the connected private properties 242 that were matched.

In addition to displaying identifying information for the connected private properties 242 that are matched to the vehicle 100.

In some implementations, the results of the matching may be sorted into an order based on one or more factors such as distance between the vehicle 100 and the connected private property 242, compatibility or difference between the rated power output for the charging station 422 and the vehicle 100 or between rated power for the electrical outlet 532 and rated power input for the vehicle 100, cost (e.g., incurred penalty) for using the connected private property 242, rating of the host, etc. In some implementations, the connected private properties 242 may be displayed on the guest device 1058 in the sorted order. Furthermore, sorting matching infrastructure may be performed or enhanced by an AI/ML model that may predict which of the connected private properties 242 are most likely to be selected by the guest. In some implementations, the sorting order of the matched charging infrastructure (e.g., the connected private property 242) may be based on a probability output of the AI/ML model predicting the probability that the guest will select a given one of the connected private properties 242.

In some implementations, where multiple of the connected private properties 242 are matched to the vehicle 100, the matching 1303 may include selecting one of the connected private properties 242 from the multiple of the connected private properties 242. In some implementations, the guest may perform the selection via, for example, the I/O interface 1710 of the guest device 1058. To aid the guest in selecting one of the connected private properties 242, information about the connected private properties 242 may be displayed about each of the multiple of the connected private properties 242 that were matched to the vehicle 100. For example, a penalty (e.g., cost) for using the connected private properties 242 may be displayed as is explained in further detail below. Other information may also be displayed, including the amount of power that may be received from the connected private property 242 if the vehicle 100 were to use the connected private property 242 to charge the vehicle 100 for a certain duration (e.g., for the duration of a scheduled use of the connected private property 242 or for the duration of a given time slot for using the connected private property 242). Furthermore, an additional estimated range that the vehicle 100 may acquire (e.g., based on the characteristics of the vehicle 100) by using the connected private property 242 to charge the vehicle 100 for a certain period of time (e.g., for the duration of a scheduled use of the connected private property 242 or for the duration of a given time slot for using the connected private property 242). For example, a guest who plans to travel in the vehicle 100 along a planned route of a certain distance may use this information to ensure that the vehicle 100 will have adequate charge to reach the destination.

In other implementations, one of the connected private properties 242 from the multiple of the connected private properties 242 based on a prediction which of the connected private properties 242 are most likely to be selected by the guest (e.g., by the AI/ML model). Where the matching 1303 include selecting one of the connected private properties 242, the selected one of the connected private properties 242 may be referred to herein as the matched one of the connected private properties 242.

The method 1300 may also include controlling 1304 an operation of the vehicle 100 and/or the connected private property 242 based at least on the vehicle 100 being matched with the connected private property 242. For example, upon the vehicle 100 matching with the connected private property 242, the guest device 1058 and/or the application 1057 (e.g., running the server device 1055) may cause (e.g., cause) the guest device 1058 to display (e.g., the display device 1171 of the guest device 1058) to display additional information about the connected private property 242 that was matched. This additional information may include, for example, the address for the connected private property 242 or other information about the connected private property 242 that may not be displayed until the connected private property 242 is matched to the vehicle 100. In some implementations, the additional information may not be displayed until a certain condition is met. For example, the address for the connected private property 242 may not be displayed until the passing of a temporal threshold (e.g., one day before a scheduled charge event, 12 hours before a scheduled charge event, 5 minutes before a scheduled charge event, etc.) or upon relinquishing of a penalty (e.g., payment).

As another example, upon the vehicle 100 matching with the connected private property 242, the guest device 1058 and/or the application 1057 (e.g., running on the server device 1055) may cause (e.g., automatically cause) a charging appointment to be scheduled for use of the connected private property 242. For example, where a characteristic of the vehicle 100 is a desire to use a charger at a certain time, upon the vehicle 100 matching with the connected private property 242 having an availability at that time, a charging appointment for using the connected private property 242 may be automatically scheduled (e.g., on a calendar associated with the connected private property 242). As another example, where the vehicle 100 has autonomous driving capabilities, upon the vehicle 100 matching with the connected private property 242, the guest device 1058 and/or the application 1057 (e.g., running on the server device 1055) may cause (e.g., automatically cause) the vehicle 100 to autonomously drive to the connected private property 242. For example, the guest device 1058 may send a signal to the control system 108 of the vehicle 100 to cause the control system 108 to generate control operations to send to various systems of the vehicle 100 to autonomously drive the vehicle 100 to the connected private property 242.

Furthermore, in implementations where the charging station 422 includes the articulating arm 848, upon the vehicle 100 matching with the connected private property 242, the guest device 1058 and/or the application 1057 (e.g., running on the server device 1055) may cause (e.g., automatically cause) the articulating arm 848 to deploy to connect the charging connector 424 to the charging inlet 321 of the vehicle 100 and initiate the supply of electrical power to the vehicle 100. For example, the guest device 1058 may send a signal to controller 428 of the charging station 422 to cause the controller 428 to generate control operations to cause the articulating arm 848 to deploy and initiate charging. Furthermore, in implementations where the connected private property 242 includes the wireless charging pad 951, upon the vehicle matching with the connected private property 242, the guest device 1058 and/or the application 1057 (e.g., running on the server device 1055) may cause (e.g., automatically cause) the wireless charging pad 951 to initiate the supply of electrical power to the vehicle 100. For example, the guest device 1058 may send a signal to the controller 428 of the charging station 422 to cause the controller 428 to generate control operations to initiate charging of the vehicle 100 via the wireless charging pad 951. Other operations of the vehicle 100 and/or the connected private property 242 may also be controlled based on the vehicle 100 matching to the connected private property 242.

As another example, upon the vehicle 100 matching with the connected private property 242 and the vehicle 100 is connected to either the charging station 422 (or the electrical outlet 532), the guest device 1058 and/or the application 1057 (e.g., running on the server device 1055) may either cause (e.g., automatically cause) the controller 428 (or the controller 535) to throttle the actual power being supplied (e.g., the actual amperage being supplied) to the vehicle 100 to be compatible with (e.g., meet or fall below) the rated power input for charging the one or more batteries 109, or may cause the control system 108 of the vehicle 100 to throttle the actual power being received by one or more batteries 109 to be compatible with (e.g., meet or fall below) the rated power output for the connected private property 242. For example, upon the vehicle 100 matching with the connected private property 242 and connecting the vehicle 100 to the charging station 422, a signal may be sent to the controller 428 to throttle the actual power output of the charging station 422 to be compatible with the rated power input for charging the one or more batteries 109 of the vehicle 100.

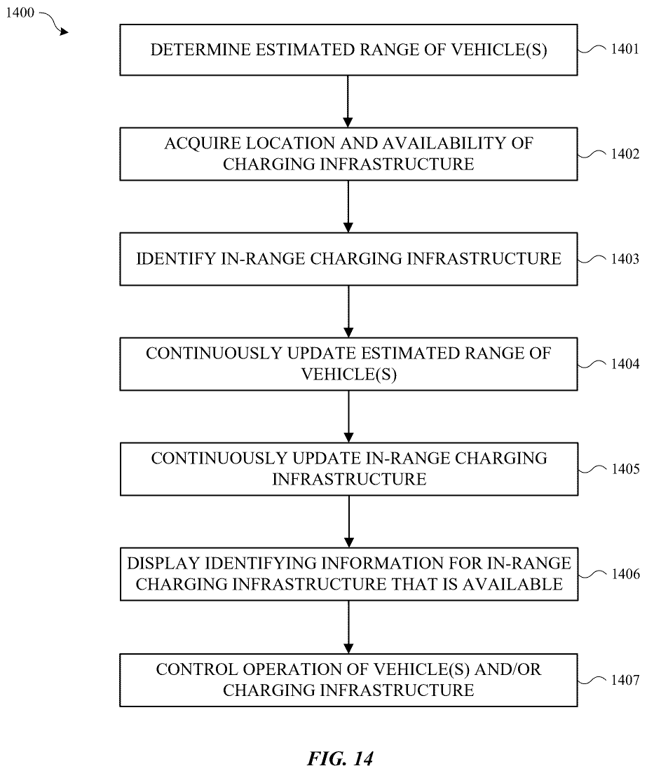

FIG. 14 is a flowchart of another example of a method 1400 for matching the vehicle 100 with the connected private property 242 (e.g., matching the vehicle 100 with the matched charging infrastructure 1277 as described above) and controlling an operation of the vehicle 100 and/or the connected private property 242 based thereon. The method 1400 may include determining 1401 an estimated range of the vehicle 100. The estimated range of the vehicle 100 may be determined, for example, based on the charge level 111 of the one or more batteries 109 of the vehicle 100, historical driving data for the vehicle 100, and battery life and health information for the one or more batteries 109 (e.g., from the BCM of the control system 108).

The method 1400 may also include acquiring 1402 a location of the connected private properties 242 and present and/or future availabilities for using the connected private property 242 for charging. The method 1400 may also include identifying 1403 the connected private properties 242 that are in-range of the vehicle 100 based on, for example, the estimated range of the vehicle 100. The method 1400 may also include continuously updating 1404 the estimated range of the vehicle 100 based on real-time (e.g., continuously updating) charge level information for the one or more batteries 109, real-time (e.g., continuously updating) historical driving data for the vehicle 100, and real-time (e.g., continuously updating) battery life and health information for the one or more batteries 109.

The method 1400 may also include continuously updating 1405 the connected private properties 242 that are in-range of the vehicle 100 based on, for example, the continuously updating estimated range of the vehicle 100. The method 1400 may also include displaying 1406 identifying information for the connected private properties 242 that are in range. In some implementations, only the connected private properties 242 that are in range and that are currently available may be displayed. The identifying information for the connected private properties 242 may be displayed via the display device 1171 (e.g., the display device 1171 of the guest device 1058). The method 1400 may also include controlling 1407 operations of the vehicle 100 and/or the connected private property 242 as described above with respect to the method 1300 described with respect to FIG. 13.

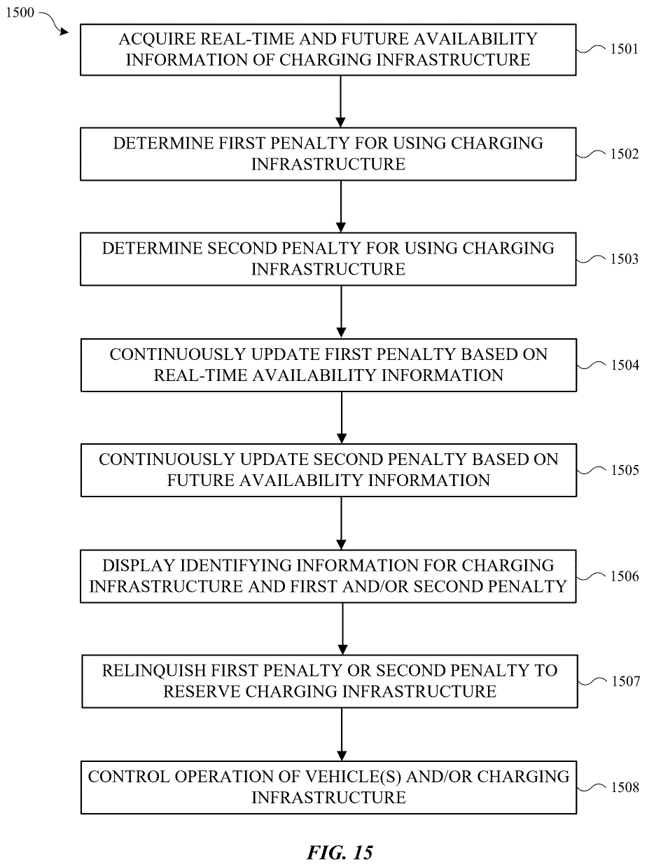

FIG. 15 is a flowchart of another example of a method 1500 for matching the vehicle 100 with the connected private property 242 (e.g., matching the vehicle 100 with the matched charging infrastructure 1277 as described above) and controlling an operation of the vehicle 100 and/or the connected private property 242 based thereon. The method 1500 may include acquiring current (e.g., real-time) and future availability for the connected private properties 242. The availability of the connected private property 242 may be in the form of appointments (e.g., ranges of times), the length of which may be determined by the host associated with the connected private property 242.

The method 1500 may also include determining 1502 a first penalty (e.g., a cost, a price, a rate) for using the connected private property 242 within a temporal threshold. For example, the first penalty for using the connected private property 242 may be discounted to encourage guests to use the currently available charging infrastructure within a temporal threshold (e.g., within 5 minutes, within 10 minutes, within 30 minutes, etc.). The first penalty may be determined based on, for example, the real-time availability of the connected private property 242, the real-time electricity cost in the geographic region, the real-time demand for the connected private property 242, preferences of the host associated with the connected private property 242, and/or other conditions. In some implementations, the temporal threshold is based on the range of the vehicle 100 (e.g., based on the charge level 111 of the one or more batteries 109).

The method 1500 may also include determining 1503 a second penalty (e.g., a cost, a price, a rate) for using the connected private property 242 at a future time (e.g., at a time beyond the temporal threshold). The second penalty may be determined based on, for example, the future availability of the connected private property 242 (e.g., beyond the temporal threshold), the estimated future electricity cost in the geographic region, the estimated future demand for the connected private property 242, preferences of the host associated with the connected private property 242, and/or other conditions.

The method 1500 may also include continuously updating 1504 the first penalty based on, for example, monitoring the real-time availability of the connected private property 242, the real-time electricity cost in the geographic region, the real-time demand for the connected private property 242, and/or other conditions.

The method 1500 may also include continuously updating 1505 the second penalty based on, for example, monitoring the future availability of the connected private property 242 (e.g., beyond the temporal threshold), the estimated future electricity cost in the geographic region, the estimated future demand for the connected private property 242, and/or other conditions.

The method 1500 may also include displaying 1506 identifying information for the connected private properties 242. In some implementations, the first penalty and/or the second penalty may be displayed with the identifying information for the connected private properties 242. In some implementations, only the first penalty may be displayed prior to the expiration of temporal threshold and only the second penalty may be displayed after the expiration of the temporal threshold. The identifying information for the connected private properties 242 and the first penalty and/or the second penalty may be displayed via the display device 1171 (e.g., the display device 1171 of the guest device 1058).

The method 1500 may also include relinquishing 1507 either the first penalty or the second penalty to reserve (e.g., schedule) the connected private property 242 for use by the vehicle 100. In some implementations, relinquishing the first penalty may cause (e.g., automatically cause) the connected private property 242 to be reserved for immediate use (e.g., use before expiration of the temporal threshold). Furthermore, in some implementations, relinquishing the second penalty may cause (e.g., automatically cause) the connected private property 242 to be reserved for future use (e.g., based on the characteristics of the vehicle 100). In some implementations, relinquishing the first penalty and/or the second penalty may be facilitated by the guest device 1058 through communication with a third-party application.

The method 1500 may also include controlling 1508 operations of the vehicle 100 and/or the connected private property 242 as described above with respect to the method 1300 discussed with respect to FIG. 13.

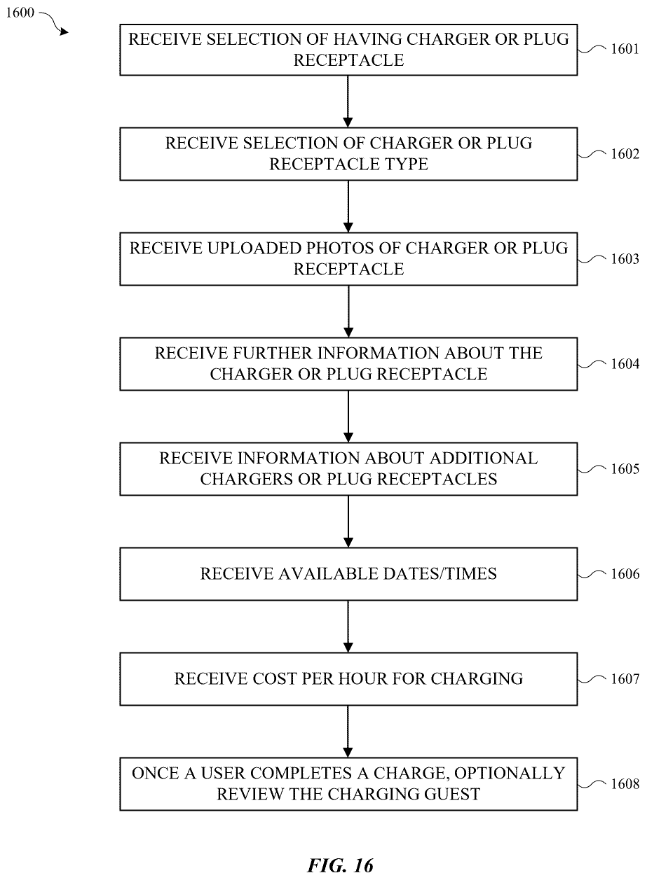

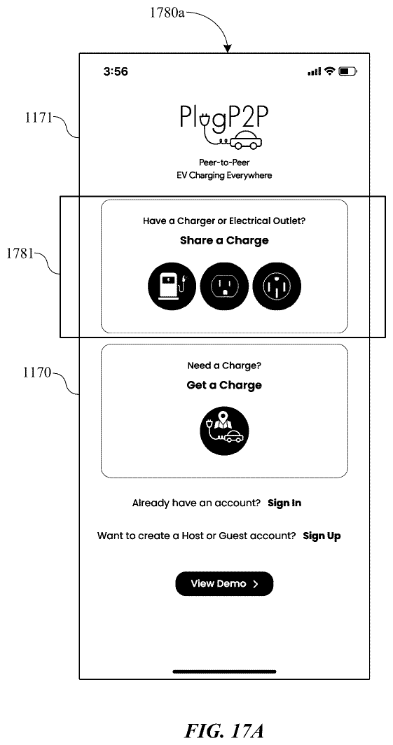

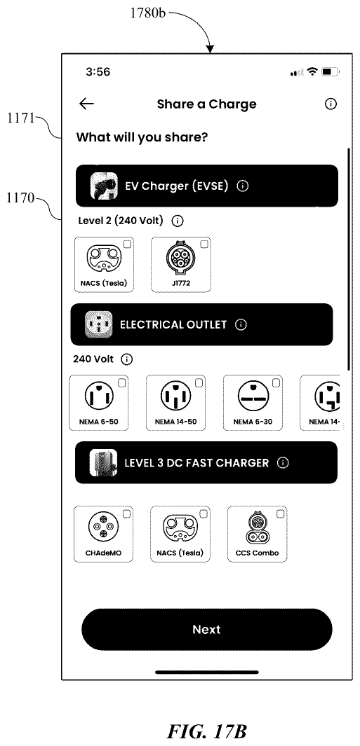

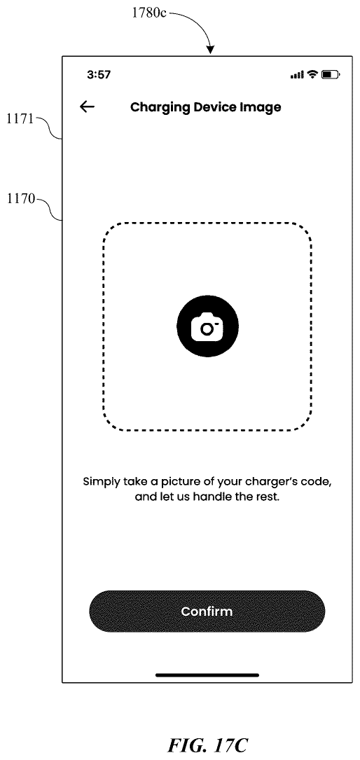

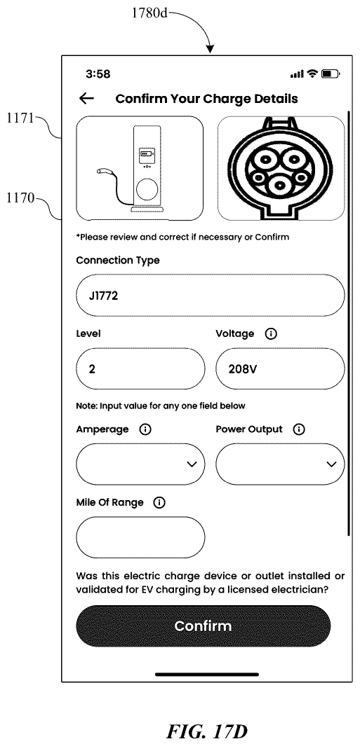

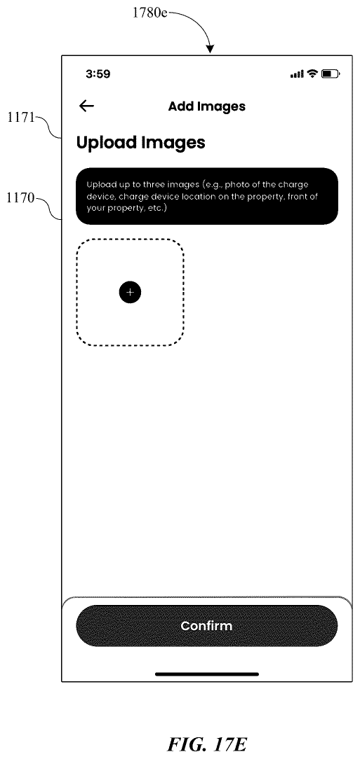

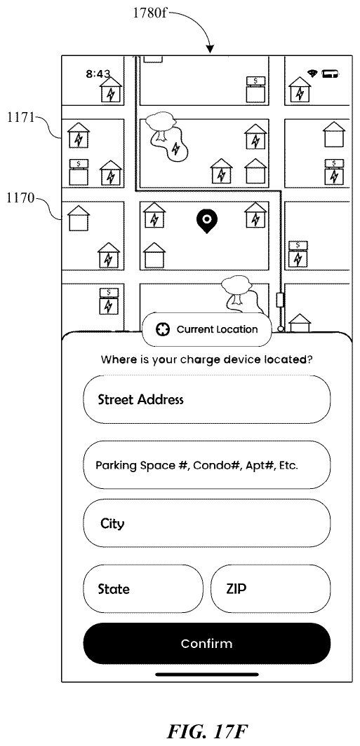

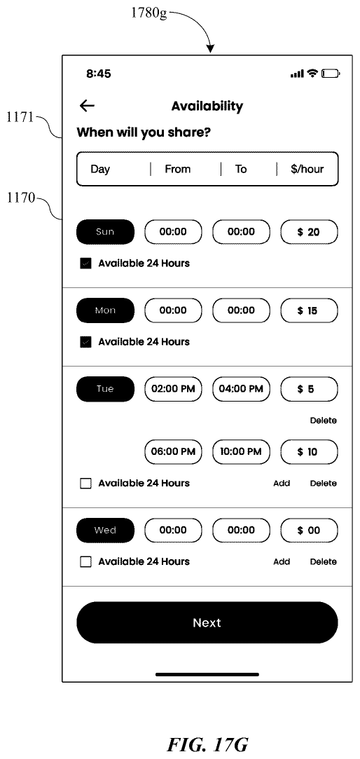

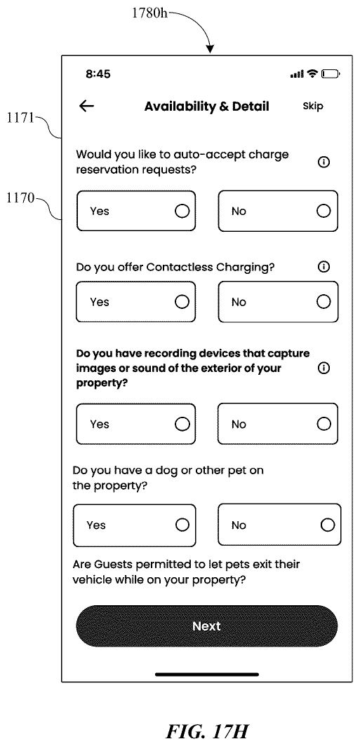

FIG. 16 is a flowchart of another example of a method 1600 for a host associated with the connected private property 242 to initiate matching with a guest associated with an EV (e.g., the vehicle 100) as described herein. The method 1600 may be facilitated at least in part by the I/O interface 1170 of the host device 1059. The method 1600 may include receiving 1601 (e.g., acquiring) a selection of whether the connected private property 242 associated with the host includes the charging connector 424 (e.g., includes the charging station 422) or includes the electrical outlet 532 (see e.g., the graphical user interface (GUI) 1780b illustrated in FIG. 17B).

The method 1600 may also include receiving 1602 (e.g., acquiring) a selection of the geometry (e.g., type) of the charging connector 424 or the electrical outlet 532 (see e.g., the GUI 1780b illustrated in FIG. 17B). The method 1600 may also include receiving 1603 (e.g., acquiring) one or more photos of the charging connector 424 or the electrical outlet 532 (see e.g., the GUI 1780c illustrated in FIG. 17C). In some implementations, the one or more images may be interpreted (e.g., using an image recognition model) to verify that the geometry received at the receiving 1602 is accurate. In some implementations, the one or more images may not be interpreted, and may rather be uploaded to a user profile for the host (see e.g., the GUI 1780d illustrated in FIG. 17D).

The method 1600 may also include receiving 1604 (e.g., acquiring) further information about the charging connector 424 or the electrical outlet 532, which may include, for example, the characteristics of the connected private properties 242 as described previously with respect to FIG. 12B (see e.g., the GUI 1780h illustrated in FIG. 17H). For example, one or more additional images of the charging connector 424, the electrical outlet 532, or of the connected private property 242 may be received (see e.g., the GUI 1780e illustrated in FIG. 17E). As another example, the location of the connected private property 242 may be received (see e.g., the GUI 1780f illustrated in FIG. 17F).

The method 1600 may also include receiving 1605 (e.g., acquiring) information about additional ones of the charging connector 424 and/or the electrical outlet 532 located on the connected private property 242. The method 1600 may also include receiving 1606 (e.g., acquiring) availability information for the connected private property 242. For example, the host may set times at which they would like to accept guests to use the connected private property 242 (see e.g., the GUI 1780g illustrated in FIG. 17G).

The method 1600 may also include receiving 1607 a cost (e.g., a penalty) for using the connected private property 242 (see e.g., the GUI 1780g illustrated in FIG. 17G). In some implementations, the cost (e.g., the penalty) may be on a per-hour basis. In other implementations, the cost (e.g., penalty) may be on some other time-basis (e.g., per 15 minutes, per 30 minutes, per day, etc.). The method 1600 may also include reviewing 1608 the guest. For example, the host may rank the guest on a five-point basis and/or leave comments for other hosts to view. In some implementations, an internal review score of the guest may be kept and/or managed by the application 1057. For example, the internal review score may increase based on the reviews left by hosts, the number of successful charging events that take place with the vehicle 100 of the guest, or other factors. Whether a charging event was successful may be determined based on the systems and methods described herein. For example, the application 1057 may communicate with the controller 428 (or the controller 535) and/or the control system 108 of the vehicle 100 to determine if power was supplied to the vehicle 100 and/or the time and/or duration at which power was being supplied to the vehicle 100.

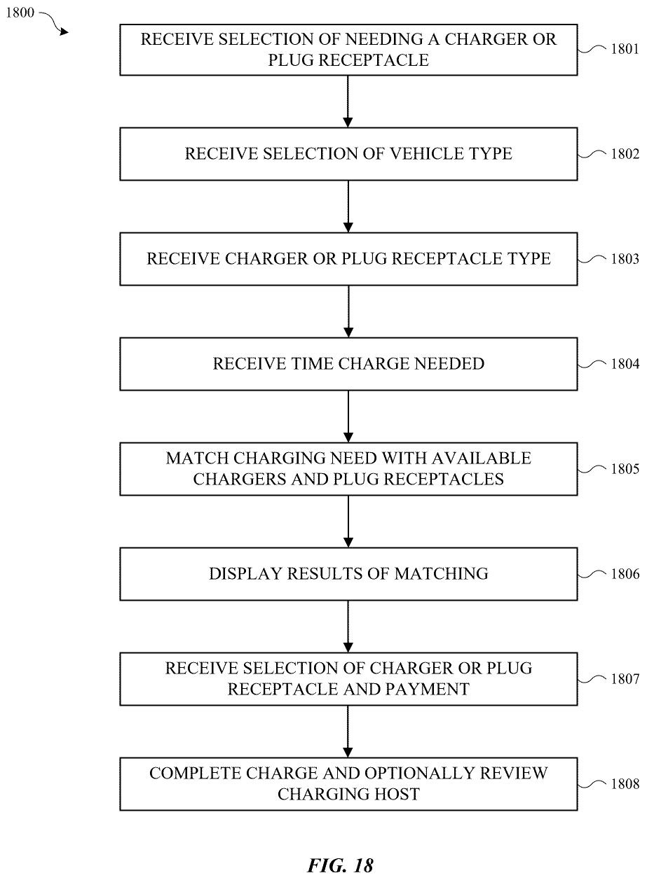

FIG. 18 is a flowchart of another example of a method 1800 for a guest associated with the vehicle 100 to initiate matching with a host associated with charging infrastructure (e.g., the connected private property 242) as described herein. The method 1800 may be facilitated at least in part by the I/O interface 1170 and/or the display device 1171 of the guest device 1058.

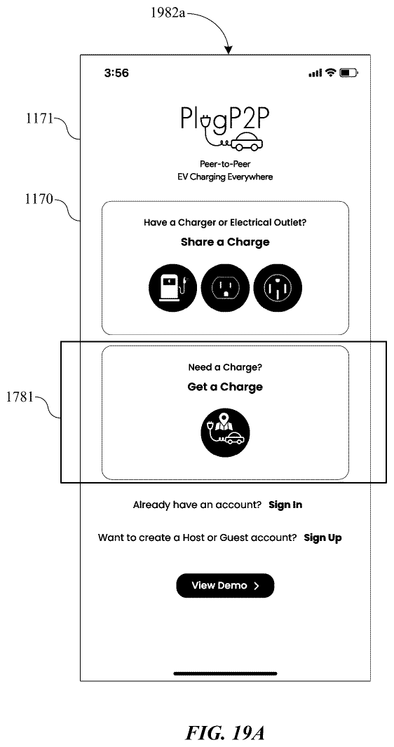

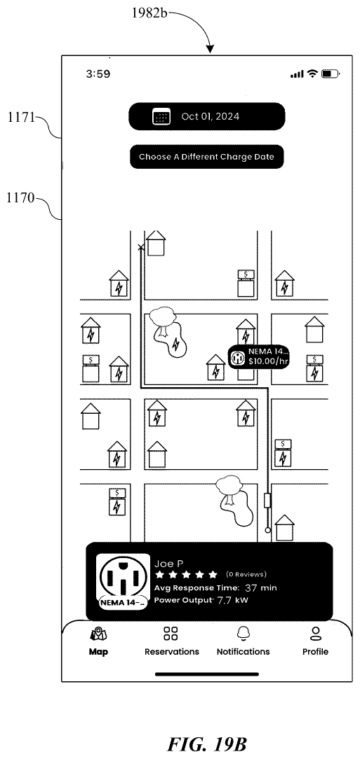

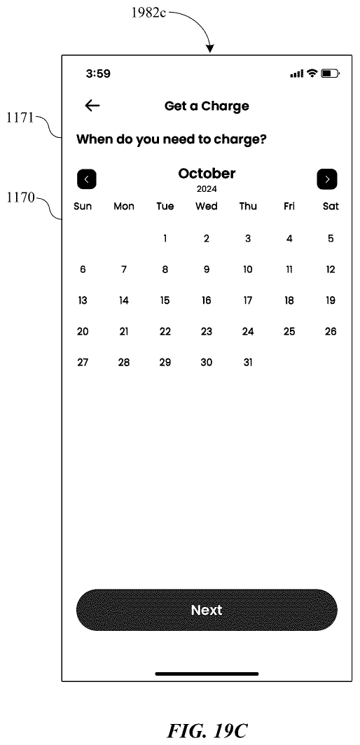

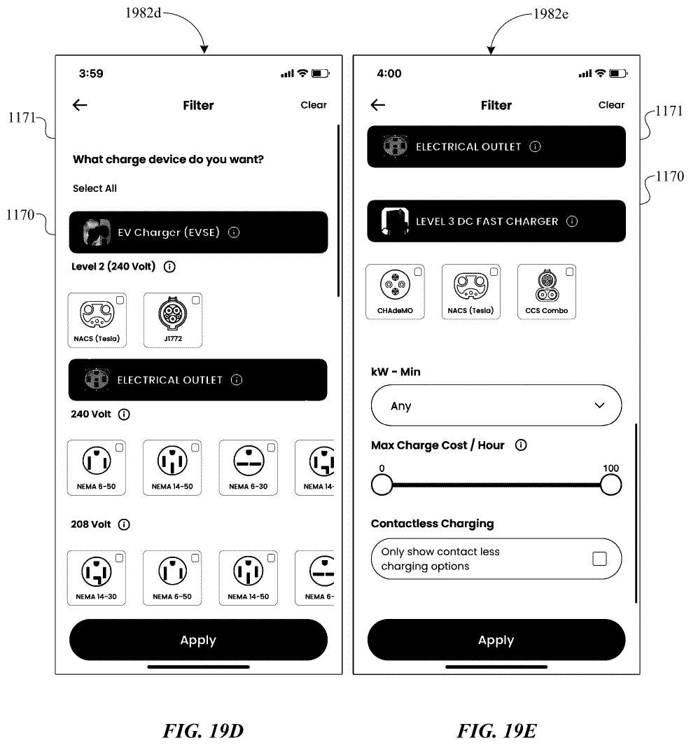

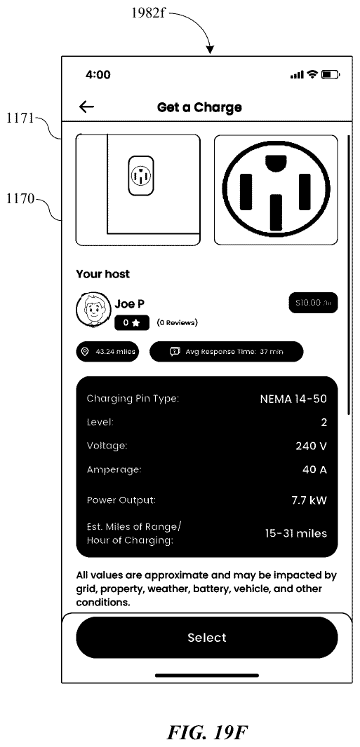

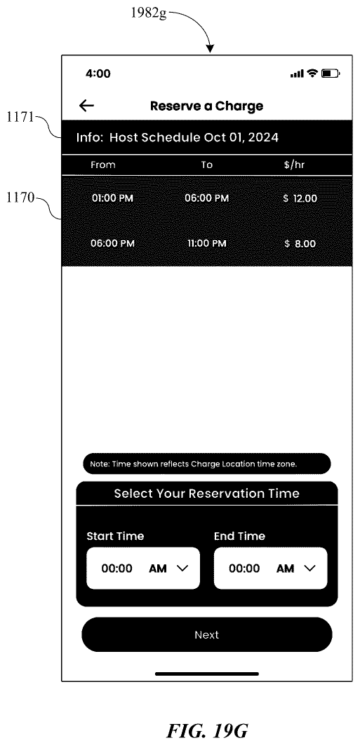

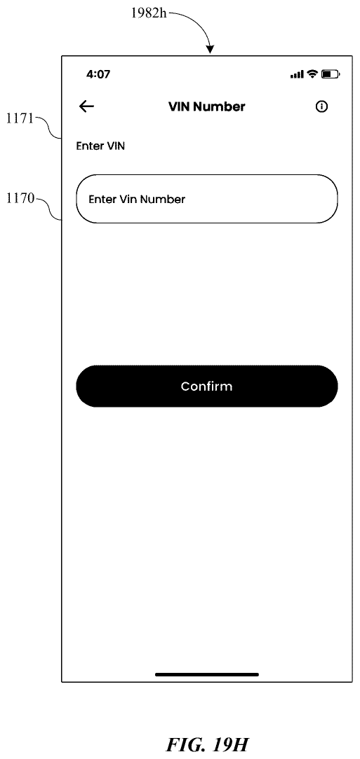

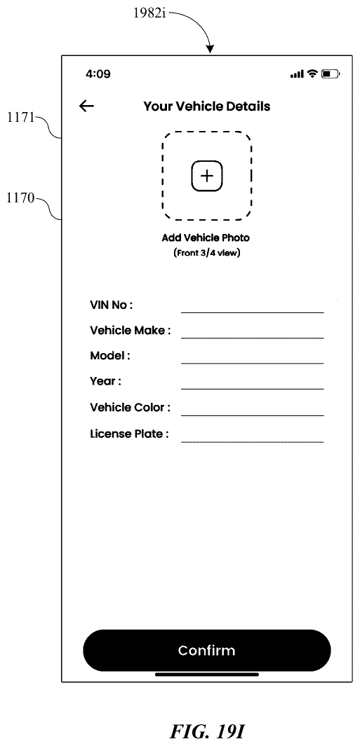

The method 1800 may include receiving 1801 (e.g., acquiring) a selection of whether the vehicle 100 associated with the guest includes the charging inlet 321 and thus requires the connected private property 242 to include the charging connector 424 or includes the portable charger 639 and thus requires the connected private property 242 to include the electrical outlet 532 (see e.g., the GUI 1982d and the GUI 1982e illustrated in FIGS. 19D-19E).

The method 1800 may also include receiving 1802 a selection of a vehicle type (e.g., the make, model, year, etc. of the vehicle 100). In some implementations, an image may be captured of the vehicle identification number (VIN) of the vehicle 100 (e.g., using the guest device 1058) which may be used to automatically provide the vehicle type information. In other implementations, the VIN may be manually uploaded which may be used to automatically provide the vehicle type information (see e.g., the GUI 1982h illustrated in FIG. 19H).

The method 1800 may also include receiving 1803 a geometry (e.g., type) of the geometry (e.g., type) of the charging connector 424 or the electrical outlet 532 that is compatible with the vehicle 100 (see e.g., the GUI 1982d and the GUI 1982e illustrated in FIGS. 19D-19E).

The method 1800 may also include receiving a time at which a charge is needed for the vehicle 100. For example, the guest may select time slots on a calendar at which the guest anticipates that the vehicle 100 will require recharging (see e.g., the GUI 1982c illustrated in FIG. 19C). As another example, time slots may be automatically selected based on an anticipated range of the vehicle 100, historical driving data for the vehicle 100, historical power consumption information for the vehicle 100, and/or battery life or health of the one or more batteries 109 of the vehicle.

The method 1800 may also include matching 1805 the charging need for the vehicle 100 with the connected private properties 242 that are available. As explained previously, the matching 1805 may include exact matching or nearest matching data. The matching 1805 may include comparing multiple factors including locations and distance between the vehicle 100 and the connected private property 242, availability of the connected private property 242 and the time that guest desires charging, make and model of the vehicle 100, the geometry of the charging inlet 321, the charging connector 424, the electrical outlet 532 and/or the electrical plug 641, etc. More than one match result may be provided (e.g., more than one of the connected private properties 242 may be matched to a single one of the vehicles 100). In some implementations, the results of the matching may be sorted based on one or more factors such as distance between the vehicle 100 and the connected private property 242, compatibility between the rated power output for the charging station 422 and/or the electrical outlet 532 and rated power input for the vehicle 100, cost (e.g., penalty) for using the connected private property 242, rating of host, etc. Furthermore, sorting matching vehicles and charging infrastructure may be performed or enhanced by an AI/ML model that may predict which of the connected private properties 242 are most likely to be selected by the guest. In some implementations, the sorting order of the matched charging infrastructure (e.g., the connected private property 242) may be based on a probability output of the AI/ML model predicting the probability that the guest will select a given one of the connected private properties 242.

The method 1800 may also include displaying 1806 the results of the matching performed at the matching 1805 step. For example, the results of the matching may be displayed on the display device 1171 of the guest device 1058. In some implementations, the results of the matching may be displayed on a graphical representation of a map (see e.g., the GUI 1982b illustrated in FIG. 19B). In some implementations the results of the matching may be displayed in the sorted order as described above.

The method 1800 may also include receiving 1807 (e.g., acquiring) a selection of a matched one of the connected private property 242 for reservation (e.g., for scheduling). In some implementations, upon selecting the connected private property 242 for reservation, the guest will be prompted to relinquish payment to reserve the connected private property 242.

In some implementations, rather than the selection of the connected private property 242 being received from the guest, the connected private property 242 may be automatically selected based on a prediction of which of the connected private properties 242 is most likely to be selected by the guest (e.g., using an AI/ML model as described above). In some implementations, the connected private property 242 may be automatically selected based on the order by which the matching the connected private properties 242 are sorted. In some implementations, the connected private property 242 may be automatically selected based on a current activity of the guest user (e.g., based on a temporal duration or a location of the current activity of the guest user). For example, where the guest is attending a short appointment (e.g., an appointment lasting less than a temporal threshold), a particular one of the connected private property 242 may be automatically selected, whereas where the guest is attending a long appointment (e.g., an appointment lasting longer than the temporal threshold), a different one of the connected private properties 242 may be automatically selected. In some implementations, a recommendation for the connected private property 242 may be provided to the guest based on a prediction of which of the connected private properties 242 is most likely to be selected by the guest (e.g., using an AI/ML model as described above), or where the guest will have the highest likelihood of charge event success and satisfaction (e.g., the connected private properties 242 being highly rated), whereby the guest may select the connected private property 242 by confirming the recommendation.

Furthermore, in some implementations, the selection of the connected private property 242 may cause (e.g., automatically cause) operations of the EV and/or the charging infrastructure to be controlled. In some implementations, the selection of the connected private property 242 may automatically cause the connected private property 242 to be scheduled for use (e.g., future use) by the guest. For example, the selection of the connected private property 242 may automatically cause a calendar associated with the host and/or the connected private property 242 to indicate a scheduled time at which the guest will utilize the connected private property 242. Additionally, the selection of the connected private property 242 may automatically cause information about the connected private property 242 (e.g., the characteristics of the connected private property 242 described above) to be displayed on the guest device 1058. Furthermore, in implementations where the EV has autonomous driving capabilities (e.g., partial or limited autonomous driving capabilities) the selection of the connected private property 242 may automatically cause the EV to drive to the connected private property 242 that was selected. For example, where the EV includes components operable to enable autonomous driving, upon selection of the connected private property 242, the EV may automatically drive to the connected private property 242 with, without, or with limited input from the guest user. Furthermore, where the connected private property 242 has been scheduled for future use by the guest, the EV may automatically drive to the connected private property 242 at or before the scheduled time. In some implementations, the guest may provide an input to approve (e.g., permit) the EV to automatically drive to the connected private property 242 at or before the scheduled time. Where the EV has autonomous driving capabilities, the EV may autonomously drive to a position directly adjacent to the charging station 422 and/or electrical outlet 532 (e.g., over the parking space 743) or may drive to a position that is spaced from the charging station 422 and/or electrical outlet 532 to be manually driven to the position directly adjacent to the charging station 422 and/or electrical outlet 532.

The method 1800 may also include reviewing 1808 the host. For example, the guest may rank the host on a five-point basis and/or leave comments for other guests to view. In some implementations, an internal review score of the host may be kept and/or managed by the application 1057. For example, the internal review score may increase based on the reviews left by guests, the number of successful charging events that take place on the connected private property 242 of the host, or other factors. Whether a charging event was successful may be determined based on the systems and methods described herein. For example, the application 1057 may communicate with the controller 428 (or the controller 535) and/or the control system 108 of the vehicle 100 to determine if power was supplied to the vehicle 100 and/or the time and/or duration at which power was being supplied to the vehicle 100.

In implementations where the EV has autonomous driving capabilities, once the charge is complete, the EV may automatically drive away from the charging infrastructure. For example, once the charge is complete, the EV may automatically drive to the guest user or to the home of the guest user.

Various implementations of features described herein may use any type of system and/or service. Any type of electronic device may make use of the features described herein. Some implementations may provide one or more features described herein on client or server devices disconnected from or intermittently connected to computer networks.

In some implementations, as illustrated in the graphic interface 1080a illustrated in FIG. 17A and the graphic interface 1982a illustrated in FIG. 19A, prior to initiating the method 1600 or the method 1800, the user of a device running the application 1057 may be required to select 1781 whether they are a host (e.g., being associated with the connected private property 242) or a guest (e.g., being associated with the vehicle 100) which will direct the user either through the method 1600 (or portions thereof) if the user selects that they are a host or through the method 1800 (or portions thereof) if the user selects that they are a guest.

One or more methods described herein (e.g., methods of FIGS. 13-16 and 18) may be implemented by computer program instructions or code, which may be executed on a computer. For example, the code may be implemented by one or more digital processors (e.g., microprocessors or other processing circuitry), and may be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions may also be contained in, and provided as, an electronic signal, for example in the form of software as a service (SaaS) delivered from a server (e.g., a distributed system and/or a cloud computing system). Alternatively, one or more methods may be implemented in hardware (logic gates, etc.), or in a combination of hardware and software. Example hardware may be programmable processors (e.g., Field-Programmable Gate Array (FPGA), Complex Programmable Logic Device), general purpose processors, graphics processors, Application Specific Integrated Circuits (ASICs), and the like. One or more methods may be performed as part of or component of an application running on the system, or as an application or software running in conjunction with other applications and operating system.

One or more methods described herein may be run in a standalone program that may be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture may be used, e.g., a mobile computing device (as a client device) sends user input data to a server device and receives from the server the final output data for output (e.g., for display). In another example, all computations may be performed within the mobile app (and/or other apps) on the mobile computing device. In another example, computations may be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may be executed on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A non-transitory computer-readable storage device including program instructions executable by one or more processors that, when executed, cause the one or more processors to perform operations, the operations comprising:
acquiring data indicative of a geometry of a charging feature of a vehicle for charging a battery of the vehicle and a rated power input for the battery of the vehicle;
acquiring data indicative of a geometry of a charging feature of charging infrastructure and a rated power output for the charging infrastructure;
matching the vehicle to the charging infrastructure based at least on the geometry of the charging feature of the vehicle being compatible with the geometry of the charging feature of the charging infrastructure; and
automatically controlling an operation of at least one of the vehicle or the charging infrastructure when the vehicle is connected with the charging infrastructure such that:
an actual power output from the charging infrastructure is compatible with the rated power input for the battery of the vehicle, or
an actual power input to the battery of the vehicle is compatible with the rated power output for the charging infrastructure.

2. The non-transitory computer-readable storage device of claim 1, wherein automatically controlling the operation of the at least one of the vehicle or the charging infrastructure when the vehicle is connected with the charging infrastructure comprises reducing the actual power input to the battery.

3. The non-transitory computer-readable storage device of claim 1, wherein automatically controlling the operation of the at least one of the vehicle or the charging infrastructure when the vehicle is connected with the charging infrastructure comprises reducing the actual power output from the charging infrastructure.

4. The non-transitory computer-readable storage device of claim 1, wherein the operations further comprise:
acquiring data indicative of an availability of the charging infrastructure; and
acquiring data indicative of an estimated time at which the battery of the vehicle will require recharging,
wherein matching the vehicle to the charging infrastructure is based further on the availability of the charging infrastructure at the estimated time at which the battery of the vehicle will require recharging.

5. The non-transitory computer-readable storage device of claim 4, wherein the estimated time at which the battery of the vehicle will require recharging is based on a current charge of the battery, wherein the operations further comprise:
continuously updating the estimated time at which the battery of the vehicle will require recharging based on the current charge of the battery.

6. The non-transitory computer-readable storage device of claim 1, wherein the geometry of the charging feature of the vehicle is defined by a charging inlet type, wherein the geometry of the charging feature of the charging infrastructure is defined by a charging connector type, and wherein matching the vehicle to the charging infrastructure is based at least on the charging inlet type being compatible with the connector type.

7. The non-transitory computer-readable storage device of claim 1, wherein the geometry of the charging feature of the vehicle is defined by an electrical plug type, wherein the geometry of the charging feature of the charging infrastructure is defined by an electrical outlet type, and wherein matching the vehicle to the charging infrastructure is based at least on the electrical outlet type being compatible with the electrical plug type.

8. A device associated with a user of a vehicle, the vehicle including a battery configured to provide power to move the vehicle, the battery having a charge level, the device comprising:
one or more memories; and
one or more processors that are configured to execute instructions that are stored in the one or more memories, wherein the instructions, when executed, cause the one or more processors to:
determine an estimated range for the vehicle based on the charge level for the battery of the vehicle;
acquire data indicative of a location and a current availability for each of one or more units of charging infrastructure;
identify one or more in-range units of charging infrastructure from the one or more units of charging infrastructure that have a distance to the vehicle that is within the estimated range for the vehicle;
continuously update the estimated range for the vehicle based on the charge level for the battery as the vehicle moves;
continuously update the one or more in-range units of charging infrastructure that are identified from the one or more units of charging infrastructure based on the estimated range for the vehicle that is continuously updated; and
display identifying information for the one or more in-range units of charging infrastructure that are identified from the one or more units of charging infrastructure and that are currently available.

9. The device of claim 8, wherein determining the estimated range for the vehicle is based further on historical power consumption data for the battery of the vehicle.

10. The device of claim 8, wherein determining the estimated range for the vehicle is based further on a planned route for the vehicle.

11. The device of claim 8, wherein the instructions, when executed, further cause the one or more processors to:
acquire data indicative of a compatibility between the vehicle and each of the one or more units of charging infrastructure;
identify one or more incompatible units of charging infrastructure from the one or more units of charging infrastructure that are incompatible with the vehicle; and
abstain from displaying identifying information for the one or more incompatible units of charging infrastructure.

12. The device of claim 11, wherein the compatibility between the vehicle and the one or more units of charging infrastructure is based in part on a geometry of a charging feature of the vehicle being compatible with a geometry of a charging feature of each of the one or more units of charging infrastructure.

13. The device of claim 12, wherein the compatibility between the vehicle and the one or more units of charging infrastructure is based further on a rated power input for the battery of the vehicle being compatible with a rated power output for each of the one or more units of charging infrastructure.

14. The device of claim 8, wherein the vehicle includes a control system, and wherein the device is integrated with the control system of the vehicle.

15. A device associated with a vehicle, the vehicle including a battery configured to provide power to control an operation of the vehicle, the device comprising:
one or more memories; and
one or more processors that are configured to execute instructions that are stored in the one or more memories, wherein the instructions, when executed, cause the one or more processors to:
acquire data indicative of a real-time availability and a future availability for using each of one or more units of charging infrastructure;
determine a first penalty for using each of the one or more units of charging infrastructure within a temporal threshold based at least on the real-time availability of each of the one or more units of charging infrastructure;
determine a second penalty for using each of the one or more units of charging infrastructure at a future time beyond the temporal threshold based at least on the future availability of the one or more units of charging infrastructure;
continuously update the second penalty for using each of the one or more units of charging infrastructure at the future time beyond the temporal threshold based at least on the future availability for using each of the one or more units of charging infrastructure; and
display identifying information for at least one of the one or more units of charging infrastructure and at least one of the first penalty or the second penalty for using the at least one of the one or more units of charging infrastructure.

16. The device of claim 15, wherein the future time is based at least on a real-time distance between the device and each of the one or more units of charging infrastructure.

17. The device of claim 16, wherein the instructions, when executed, further cause the one or more processors to:
continuously update the future time based on the real-time distance between the device and each of the one or more units of charging infrastructure.

18. The device of claim 15, wherein the instructions, when executed, further cause the one or more processors to:
relinquish the second penalty to cause a unit of infrastructure from the one or more units of charging infrastructure to be scheduled for use at the future time by the vehicle.

19. The device of claim 15, wherein the temporal threshold is based on a real-time distance between the device and each of the one or more units of charging infrastructure.

20. The device of claim 15, wherein the identifying information for the at least one of the one or more units of charging infrastructure is displayed on a graphical representation of a map.
